(19) United States
(12) Patent Application Publication
(10) Pub. No.: US 2023/0159710 A1
(43) Pub. Date: May 25, 2023

(54) Two-Dimensional Coordination Polymer Based On Isocyano Coordination

(71) Applicant: Shanghai Jiao Tong University, Shanghai (CN)

(72) Inventors: Xiaodong Zhuang, Shanghai (CN); Boxu Feng, Shanghai (CN); Yazhen Zhao, Shanghai (CN); Yifei Jiao, Shanghai (CN); Ke Wang, Shanghai (CN)

(21) Appl. No.: 17/881,389

(22) Filed: Aug. 4, 2022

Related U.S. Application Data
(63) Continuation-in-part of application No. PCT/CN2021/134210, filed on Nov. 30, 2021.

(30) Foreign Application Priority Data
Nov. 24, 2021 (CN) 202111400816.X

(51) Int. Cl. C08G 83/00

(52) U.S. Cl. CPC C08G 83/008

(57) ABSTRACT

Provided are isocyano-based two-dimensional coordination polymers, with coordination via a carbon atom and a transition metal ion. Not only the varieties of existing two-dimensional coordination polymers are expanded, but also the possibility to develop polymers with new properties is provided.

### RELATED APPLICATION

The present application is a continuation-in-part of International Application No. PCT/CN2021/134210 filed Nov. 30, 2021, which claims priority to Chinese Patent Application No. 202111400816.X filed on Nov. 24, 2021, the disclosures of which are incorporated herein in their entirety by reference.

### FIELD OF THE INVENTION

The present invention belongs to the field of organic two-dimensional polymers, and particularly relates to two-dimensional coordination polymers based on isocyano coordination.

### DESCRIPTION OF THE PRIOR ART

Coordination polymers have good application prospects in many fields due to their rich pore structure and ultra-high specific surface area, the most prominent of which is gas separation and storage. Traditional coordination polymers usually have a wide band gap (greater than 3 eV) and narrow energy band distribution, so that most coordination polymers do not contain any low-energy charge transport paths and highly delocalized carriers. Therefore, it often appears as an electrical insulator with a conductivity lower than 10⁻¹² S/m, which greatly limits the application of such materials in the fields of energy and electronics, such as fuel cells, supercapacitors, thermal appliances, and resistance sensing. Since the beginning of the 21st century, information, energy, and materials have become the three pillars of modern science and technology. The intersecting and coordinated development of the three fields has become an inevitable requirement for the development of science and technology. Therefore, how to design and synthesize coordination polymers with certain conductivity has become one of the hotspots in the field of coordination polymer research to enable it to be used in emerging fields such as information and energy, and has received extensive attention from scientists.

With the continuous development of coordination polymer conductivity theory and measurement technology. A series of coordination polymers with higher conductivity (10⁻⁵-10⁵ S/m) have been reported. Since the coordination bond is a medium-strength and dynamic equilibrium bonding method, compared with one-dimensional and three-dimensional coordination polymers, two-dimensional coordination polymers have higher bond-forming adjustability in the entire structure, and two-dimensional nanomaterials have no electronic confinement of strong interaction between layers and thickness at the nanometer scale, so the electronic characteristics are unique, the mechanical processability is flexible and the optical transparency can be adjusted. It can be expected that by rational design, coordination polymer materials with more complete structures and better electrical properties can be prepared. At present, a variety of ultra-high conductivity two-dimensional coordination polymers have been reported. According to the conjugation method, in the plane, they can be divided into conductive non-conjugated two-dimensional coordination polymers and conductive conjugated two-dimensional coordination polymers. At present, only a small number of conductive non-conjugated two-dimensional coordination polymers have been reported. According to the different coordination groups, conductive non-conjugated two-dimensional coordination polymers can be divided into organic oxygen-containing ligands, organic sulfur ligands, and organic nitrogen-containing ligands. Two-dimensional conjugated coordination polymers are currently reported as coordination polymer materials with the highest carrier mobility. This type of conductive two-dimensional coordination polymer mostly uses the coordination reaction of conjugated organic ligands containing N, O or S atoms and transition metal ions to form a new type of material with a planar structure similar to graphene honeycomb. Although more and more conductive two-dimensional coordination polymers have been reported, the coordination elements in their ligands are always limited to conjugated organic ligands containing N, O or S atoms. Therefore, design and development of two-dimensional coordination polymers with coordination via C atoms can not only expand the varieties of existing two-dimensional coordination polymers, but also provide the possibility to develop polymers with new properties.

### SUMMARY OF THE INVENTION

In view of the above-mentioned deficiencies of the prior art, a first aspect of the present invention provides a two-dimensional coordination polymer having a structure represented by Formula (I):

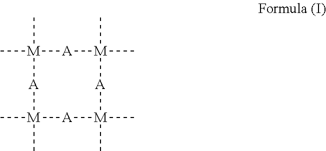

wherein
A has a structure as represented by

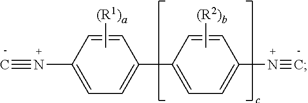

M is a metal element selected from a group consisting of Pt, Ir, Ru, Pd, Ni, Au, Cr, Co, Mo, Mn, Re, and Fe;
R¹ and R² are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
a and b are each independently 0, 1, 2, 3, or 4; and
c is an integer greater than or equal to 0 and less than or equal to 5;
wherein a carbon in an isocyano in A is connected to a metal M via a coordination bond.

A second aspect of the present invention provides a two-dimensional coordination polymer having a structure represented by Formula (II):

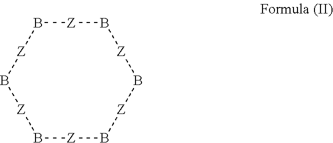

wherein:
B has a structure of

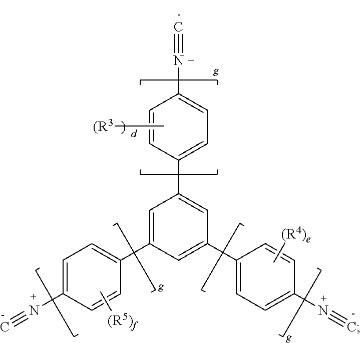

Z has a structure of

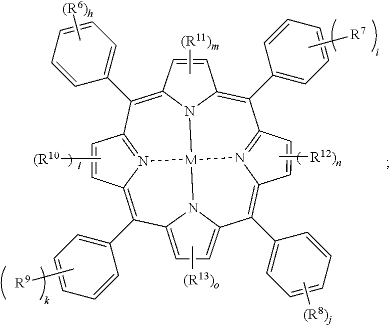

R³, R⁴, R⁵, R⁶, R⁷, R⁸, R⁹, R¹⁰, R¹¹, R¹², and R¹³ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;

d, e, and f are each independently 0, 1, 2, 3, or 4;
h, i, j, and k are each independently 0, 1, 2, 3, 4, or 5;
l, m, n, and o are each independently 0, 1, or 2;
g is an integer greater than or equal to 0 and less than or equal to 5; and
M is a metal element selected from a group consisting of Pt, Ir, Ru, Pd, Ni, Au, Cr, Co, Mo, Mn, Re, and Fe;
wherein a carbon in an isocyano in B is connected to a metal M in Z via a coordination bond.

A third aspect of the present invention provides a two-dimensional coordination polymer having a structure represented by Formula (III):

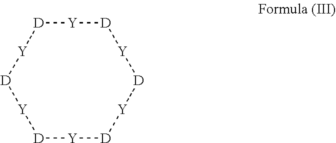

wherein:
D has a structure of

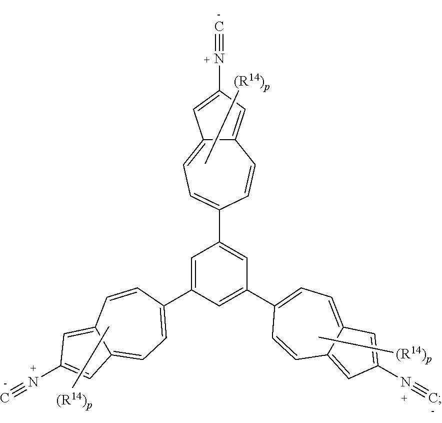

Y has a structure of

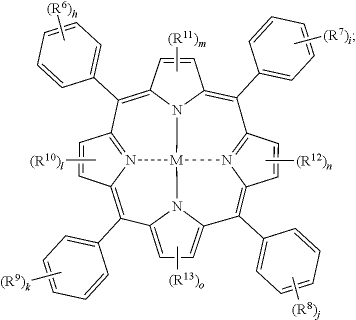

R⁶, R⁷, R⁸, R⁹, R¹⁰, R¹¹, R¹², R¹³, and R¹⁴ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
h, i, j, and k are each independently 0, 1, 2, 3, 4, or 5;
l, m, n, and o are each independently 0, 1, or 2;
p is 0, 1, 2, 3, 4, 5, or 6;
M is a metal element selected from a group consisting of Pt, Ir, Ru, Pd, Ni, Au, Cr, Co, Mo, Mn, Re, and Fe;
wherein a carbon in an isocyano in D is connected to a metal M in Y via a coordination bond.

A fourth aspect of the present invention provides a two-dimensional coordination polymer having a structure represented by Formula (IV):

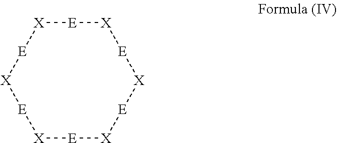

wherein:
E has a structure of

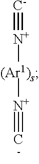

X has a structure of

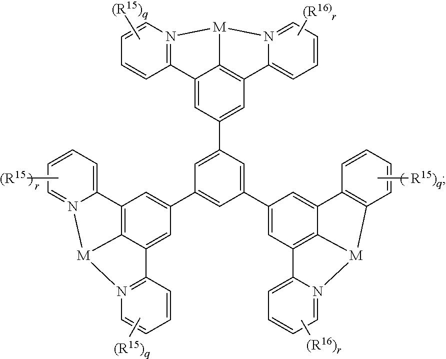

Ar¹ is unsubstituted phenyl, or phenyl substituted with one or more methyl;
R¹⁵ and R¹⁶ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
q and r are each independently 0, 1, 2, 3, or 4;
s is an integer greater than or equal to 1 and less than or equal to 5; and
M is a metal element selected from a group consisting of Pt, Ir, Ru, Pd, Ni, Au, Cr, Co, Mo, Mn, Re, and Fe;
wherein a carbon in an isocyano in E is connected to a metal M in X via a coordination bond, as shown in the following structure:

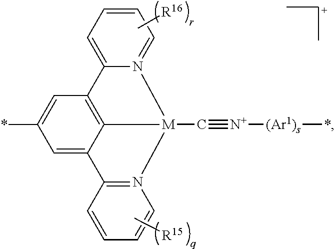

wherein * indicates a point of attachment.

A fifth aspect of the present invention provides a two-dimensional coordination polymer having a structure represented by Formula (V):

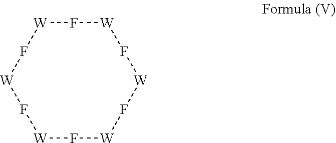

wherein:
F has a structure of

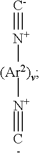

W has a structure of

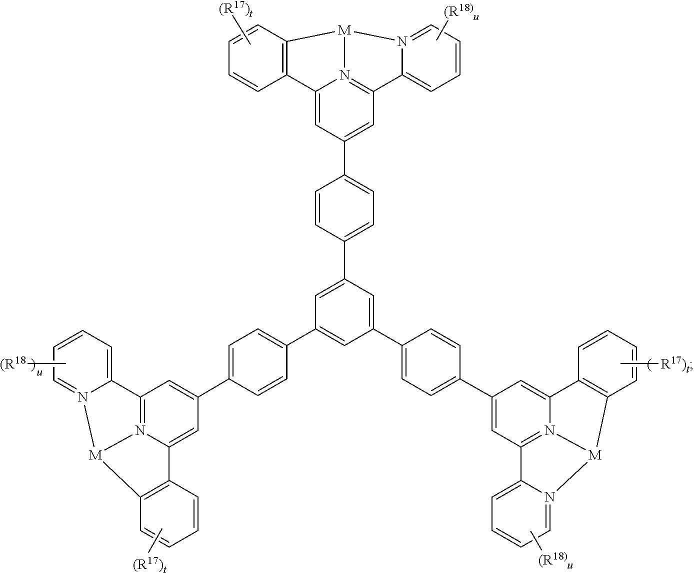

Ar² is unsubstituted phenyl, or phenyl substituted with one or more methyl;
R¹⁰ and R¹⁸ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
t and u are each independently 0, 1, 2, 3, or 4;
v is an integer greater than or equal to 1 and less than or equal to 5;
M is a metal element selected from a group consisting of Pt, Ir, Ru, Pd, Ni, Au, Cr, Co, Mo, Mn, Re, and Fe;
wherein a carbon in an isocyano in F is connected to a metal M in W via a coordination bond, as shown in the following structure:

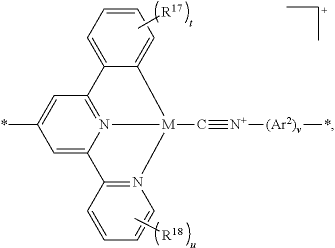

wherein * indicates a point of attachment.

Compared with the prior art, the present invention has the following beneficial technical effects:

The coordination elements in the currently reported conductive two-dimensional coordination polymer ligands are always limited to conjugated organic ligands containing N, O or S atoms. The present invention designs and develops two-dimensional coordination polymers with coordination via C atoms, which not only expands the varieties of existing two-dimensional coordination polymers, but also provides the possibility to develop polymers with new properties.

### BRIEF DESCRIPTION OF THE DRAWINGS

FIG. 1 is a hydrogen nuclear magnetic resonance spectrum of 4,4′-diisocyano-3,3′,5,5′-tetramethyl-1,1′-biphenyl (iCN-2);

FIG. 2 is a carbon nuclear magnetic resonance spectrum of 4,4′-diisocyano-3,3′,5,5′-tetramethyl-1,1′-biphenyl (iCN-2);

FIG. 3 is a hydrogen nuclear magnetic resonance spectrum of 1-bromo-2,3,5,6-tetramethyl-4-nitrobenzene (Compound 2);

FIG. 4 is a hydrogen nuclear magnetic resonance spectrum of 1,3,5-tris(2,3,5,6-tetramethyl-4-nitrophenyl)benzene (Compound 3);

FIG. 5 is a carbon nuclear magnetic resonance spectrum of 1,3,5-tris(2,3,5,6-tetramethyl-4-nitrophenyl)benzene (Compound 3);

FIG. 6 is a hydrogen nuclear magnetic resonance spectrum of 1,3,5-tris(2,3,5,6-tetramethyl-4-aminophenyl)benzene (Compound 4);

FIG. 7 is a carbon nuclear magnetic resonance spectrum of 1,3,5-tris(2,3,5,6-tetramethyl-4-aminophenyl)benzene (Compound 4);

FIG. 8 is a hydrogen nuclear magnetic resonance spectrum of 1,3,5-tris(2,3,5,6-tetramethyl-4-isocyanophenyl)benzene (iCTB);

FIG. 9 is a carbon nuclear magnetic resonance spectrum of 1,3,5-tris(2,3,5,6-tetramethyl-4-isocyanophenyl)benzene (iCTB);

FIG. 10 is a hydrogen nuclear magnetic resonance spectrum of 7-oxocyclohepta-1,3,5-trienyl 4-methylbenzenesulfonate (Compound 6);

FIG. 11 is a hydrogen nuclear magnetic resonance spectrum of 2-amino-1,3-diethoxycarbonyl azulene (Compound 7);

FIG. 12 is a hydrogen nuclear magnetic resonance spectrum of 2-amino-6-bromo-1,3-diethoxycarbonyl azulene (Compound 8);

FIG. 13 is a hydrogen nuclear magnetic resonance spectrum of hexaethyl 6,6′,6″-(benzene-1,3,5-triyl)tris(2-aminoazulene-1,3-dicarboxylate) (Compound 9);

FIG. 14 is a hydrogen nuclear magnetic resonance spectrum of hexaethyl 6,6′,6″-(benzene-1,3,5-triyl)tris(2-isocyanoazulene-1,3-dicarboxylate) (iCTA);

FIG. 15 is a hydrogen nuclear magnetic resonance spectrum of 2-bromo-6-octylpyridine (Compound 11);

FIG. 16 is a carbon nuclear magnetic resonance spectrum of 2-bromo-6-octylpyridine (Compound 11);

FIG. 17 is a hydrogen nuclear magnetic resonance spectrum of 6,6′-(5-bromo-1,3-phenylene)bis(2-octylpyridine) (Compound 12);

FIG. 18 is a carbon nuclear magnetic resonance spectrum of 6,6′-(5-bromo-1,3-phenylene)bis(2-octylpyridine) (Compound 12);

FIG. 19 is a hydrogen nuclear magnetic resonance spectrum of 6,6′,6″,6″-(5′-(3,5-bis(6-octylpyridin-2-yl)phenyl)-[1,1′:3′,1″-terphenyl]-3,3″,5,5″-tetrayl)tetrakis (2-octylpyridine) (Ph-3(N\hat{ }C\hat{ }N), Compound 13);

FIG. 20 is a hydrogen nuclear magnetic resonance spectrum of 1-(4-(tert-pentyl)phenyl)ethan-1-one (Compound 15);

FIG. 21 is a carbon nuclear magnetic resonance spectrum of 1-(4-(tert-pentyl)phenyl)ethan-1-one (Compound 15);

FIG. 22 is a hydrogen nuclear magnetic resonance spectrum of 3-(4-bromophenyl)-1-(4-(tert-pentyl)phenyl)prop-2-en-1-one (Compound 16);

FIG. 23 is a carbon nuclear magnetic resonance spectrum of 3-(4-bromophenyl)-1-(4-(tert-pentyl)phenyl)prop-2-en-1-one (Compound 16);

FIG. 24 is a hydrogen nuclear magnetic resonance spectrum of 1-[2-oxo-2-(2-pyridyl)ethyl]pyridinium iodide (Compound 17); and

FIG. 25 is a carbon nuclear magnetic resonance spectrum of 1-[2-oxo-2-(2-pyridyl)ethyl]pyridinium iodide (Compound 17).

### DETAILED DESCRIPTION OF THE PREFERRED EMBODIMENTS

A number of preferred embodiments of the present invention are introduced below with reference to the drawings of the specification to make the technical content thereof clearer and easier to understand. The present invention can be embodied by many different forms of embodiments, and the scope of protection of the present invention is not limited to the embodiments mentioned herein.

### 1. DEFINITIONS AND CLARIFICATION OF TERMS

Before describing the details of the described embodiments, some terms are defined or clarified.

Unless specifically defined otherwise, R, R′, R″, and any other variables are generic names. The specific definition of the formula given herein controls the formula.

The term “alkoxy” is intended to mean the group RO—, where R is an alkyl group.

The term “alkyl” is intended to mean a group derived from an aliphatic hydrocarbon and includes a linear, a branched, or a cyclic group. A group “derived from” a compound indicates the radical formed by removal of one or more H or D. In some embodiments, an alkyl has from 1-20 carbon atoms.

The term “fluoroalkyl” is intended to mean an alkyl group substituted with fluorine.

The term “aryl” is intended to mean a group derived from an aromatic hydrocarbon having one or more points of attachment. The term includes groups which have a single ring and those which have multiple rings which can be joined by a single bond or fused together.

The term “hydrocarbon aryl” means having only carbon in the ring structure.

The term “heteroaryl” means having at least one heteroatom in a ring structure.

The term “aryloxy” is intended to mean the group RO—, where R is an aryl group.

The term “deuterated” is intended to mean that at least one hydrogen (“H”) has been replaced by deuterium (“D”).

The term “germyl” refers to the group R₃Ge—, where R is the same or different at each occurrence and is H, D, C₁₋₂₀ alkyl, deuterated alkyl, fluoroalkyl, aryl, or deuterated aryl.

The prefix “hetero” indicates that one or more carbon atoms have been replaced with a different atom. In some embodiments, the different atom is N, O, or S.

The term “siloxane” refers to the group R₁SiO(R₂Si)—, where R₁ and R₂ are the same or different at each occurrence and are independently hydrogen, deuterium, C₁₋₂₀ alkyl, deuterated alkyl, or fluoroalkyl. In some embodiments, one or more carbons in the R₁ or R₂ alkyl groups are replaced with Si.

The term “siloxy” refers to the group R₃SiO—, where R is the same or different at each occurrence and is hydrogen, deuterium, C₁₋₂₀ alkyl, deuterated alkyl, or fluoroalkyl.

The term “silyl” refers to the group R₃Si—, where R is the same or different at each occurrence and is hydrogen, deuterium, C₁₋₂₀ alkyl, deuterated alkyl, or fluoroalkyl. In some embodiments, one or more carbons in an R alkyl group are replaced with Si.

All groups may be unsubstituted or substituted. The substituent groups are discussed below. In a structure where a substituent bond passes through the structure of one or more rings as shown below,

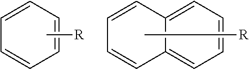

it is meant that the substituent R may be bonded at any available position on the one or more rings.

In any of the formulas or combination of formulas below, any subscript, such as h, i, j, k, that is present more than one time, may represent the same or different values at each occurrence.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the disclosed subject matter hereof, is described as consisting essentially of certain features, in which embodiment features that would materially alter the principle of operation or the distinguishing characteristics of the embodiment are not present therein. A further alternative embodiment of the described subject matter hereof is described as consisting of certain features, in which embodiment, or in insubstantial variations thereof, only the features specifically stated or described are present. Also, use of “a” or “an” is employed to describe elements and components described herein. This is done merely for convenience and to give a general sense of the scope of the present invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. In addition, the materials, methods, and examples are illustrative only and not intended to be limiting.

### 2. COORDINATION POLYMERS HAVING FORMULA (I)

In some embodiments, the two-dimensional coordination polymers described herein have a structure represented by Formula (I):

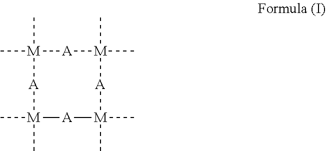

wherein
A has a structure of

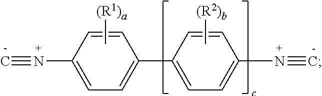

and in A, C̅≡ [symbol] indicates that the isocyano group is polar, the carbon atom tends to be negatively charged and is thus represented by C̅, and the nitrogen atom tends to be positively charged and is thus represented by [symbol] .

M is a metal element selected from the group consisting of Pt, Ir, Ru, Pd, Ni, Au, Cr, Co, Mo, Mn, Re, and Fe;

R¹ and R² are each independently selected from the group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
a and b are each independently 0, 1, 2, 3, or 4; and
c is an integer greater than or equal to 0 and less than or equal to 5;
wherein the carbon in the isocyano in A is connected to the metal M via a coordination bond.

In Formula (I), “- - -” represents a coordination bond. However, the form of expression of the coordination bond is not limited to “- - -”. For example, in a specific coordination compound with the structure of Formula (I), “- (horizontal line)” may also be used to indicate the coordination bond.

In some embodiments of Formula (I), R¹ and R² are independently methyl.

In some embodiments of Formula (I), a is 2 or 4.

In some embodiments of Formula (I), b is 2 or 4.

In some embodiments of Formula (I), c is 0 or 1.

In some embodiments of Formula (I), M is Co.

In some embodiments of Formula (I), R¹ and R² are independently methyl, a is 2, b is 2, and c is 1.

In some embodiments of Formula (I), A is 4,4′-diisocyano-3,3′,5,5′-tetramethyl-1,1′-biphenyl and has a chemical structural formula of

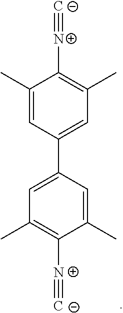

### 3. COORDINATION POLYMERS HAVING FORMULA (II)

In some embodiments, the two-dimensional coordination polymers described herein have a structure represented by Formula (II):

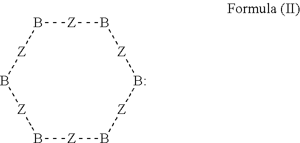

wherein:
B has a structure of

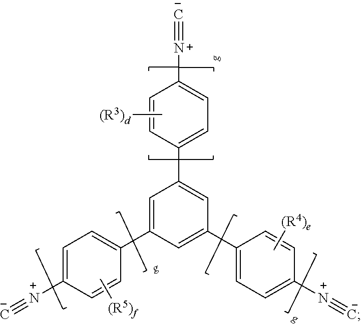

and in B, C̅≡ [symbol] indicates that the isocyano group is polar, the carbon atom tends to be negatively charged and is thus represented by C̅, and the nitrogen atom tends to be positively charged and is thus represented by [symbol] .

Z has a structure of

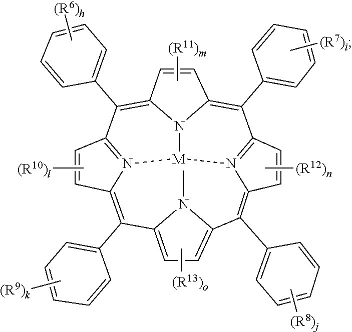

R³, R⁴, R⁵, R⁶, R⁷, R⁸, R⁹, R¹⁰, R¹¹, R₁₂, and R¹³ are each independently selected from the group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
d, e, and f are each independently 0, 1, 2, 3, or 4;
h, i, j, and k are each independently 0, 1, 2, 3, 4, or 5;
l, m, n, and o are each independently 0, 1, or 2;
g is an integer greater than or equal to 0 and less than or equal to 5; and
M is a metal element selected from the group consisting of Pt, Ir, Ru, Pd, Ni, Au, Cr, Co, Mo, Mn, Re, and Fe;
wherein the carbon in the isocyano in B is connected to the metal M in Z via a coordination bond.

In Formula (II), “ [symbol] ” represents a coordination bond. However, the form of expression of the coordination bond is not limited to “ [symbol] ”. For example, in a specific coordination compound with the structure of Formula (II), “- (horizontal line)” may also be used to indicate the coordination bond.

In some embodiments of Formula (II), R³, R⁴, and R⁵ are independently methyl.

In some embodiments of Formula (II), d, e, and f are independently 2 or 4.

In some embodiments of Formula (II), g is 1 or 2.

In some embodiments of Formula (II), h, i, j, k, l, m, n, and o are independently 0.

In some embodiments of Formula (II), R⁶, R⁷, R⁸, R⁹, R¹⁰, R¹¹, R¹², and R¹³ are independently fluorine or methyl, and h, i, j, k, l, m, n and o are independently 1 or 2.

In some embodiments of Formula (II), M is Ru.

In some embodiments of Formula (II), R³, R⁴, and R⁵ are independently methyl, d, e, and f are independently 2 or 4, and g is 1.

In some embodiments of Formula (II), h, i, j, k, l, m, n, and o are independently 0, and M is Ru.

In some embodiments of Formula (II), A is 1,3,5-tris(2,3,5,6-tetramethyl-4-isocyanophenyl)benzene and has a chemical structural formula of

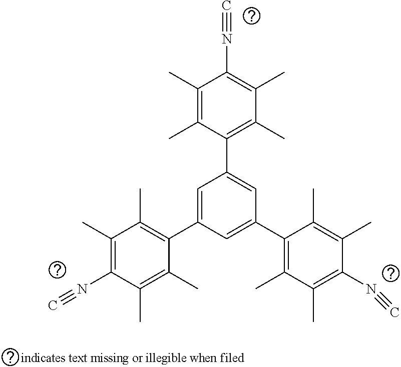

In some embodiments of Formula (II), B is

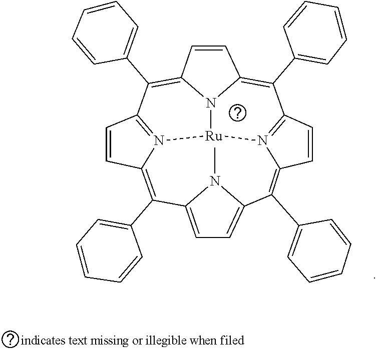

### 4. COORDINATION POLYMERS HAVING FORMULA (III)

In some embodiments, the two-dimensional coordination polymers described herein have a structure represented by Formula (III):

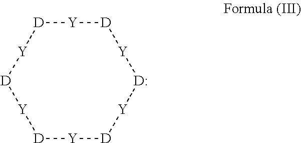

wherein:
D has a structure of

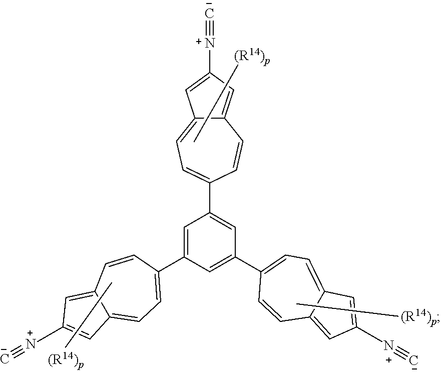

and in D, C̅≡ [symbol] indicates that the isocyano group is polar, the carbon atom tends to be negatively charged and is thus represented by C̅, and the nitrogen atom tends to be positively charged and is thus represented by [symbol] .
Y has a structure of

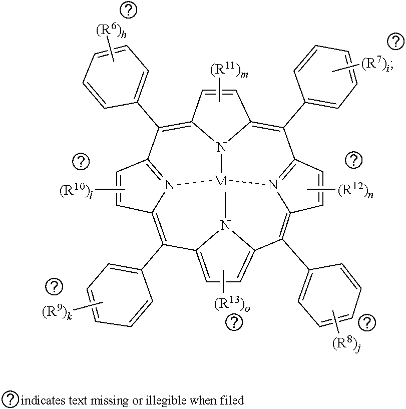

R⁶, R⁷, R⁸, R⁹, R¹⁰, R¹¹, R¹², R¹³, and R¹⁴ are each independently selected from the group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
h, i, j, and k are each independently 0, 1, 2, 3, 4, or 5;
l, m, n, and o are each independently 0, 1, or 2;
p is 0, 1, 2, 3, 4, 5, or 6;
M is a metal element selected from the group consisting of Pt, Ir, Ru, Pd, Ni, Au, Cr, Co, Mo, Mn, Re, and Fe;
wherein the carbon in the isocyano in D is connected to the metal M in Y via a coordination bond.

In Formula (III), “ [symbol] ” represents a coordination bond. However, the form of expression of the coordination bond is not limited to “ [symbol] ”. For example, in a specific coordination compound with the structure of Formula (III), “- (horizontal line)” may also be used to indicate the coordination bond.

In some embodiments of Formula (III), R¹⁴ is alkoxy.

In some embodiments of Formula (III), R¹⁴ is ethoxycarbonyl.

In some embodiments of Formula (III), p is 1 or 2.

In some embodiments of Formula (III), h, i, j, k, l, m, n, and o are independently 0.

In some embodiments of Formula (III), R⁶, R⁷, R⁸, R⁹, R¹⁰, R¹¹, R¹², and R¹³ are independently fluorine or methyl, and h, i, j, k, l, m, n and o are independently 1 or 2.

In some embodiments of Formula (III), M is Ru.

In some embodiments of Formula (III), R¹⁴ is ethoxycarbonyl, and p is 2.

In some embodiments of Formula (III), h, i, j, k, l, m, n, and o are independently 0, and M is Ru.

In some embodiments of Formula (III), D is hexaethyl 6,6′,6″-(benzene-1,3,5-triyl)tris(2-isocyanoazulene-1,3-dicarboxylate) and has a chemical structural formula of

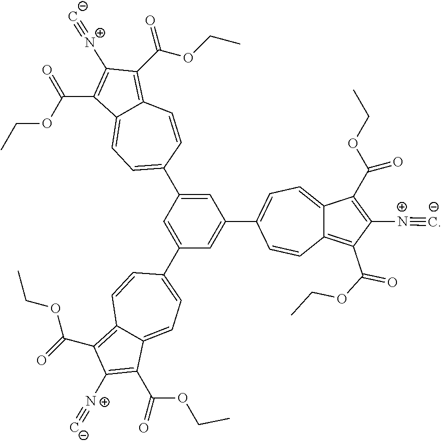

In some embodiments of Formula (III), Y is

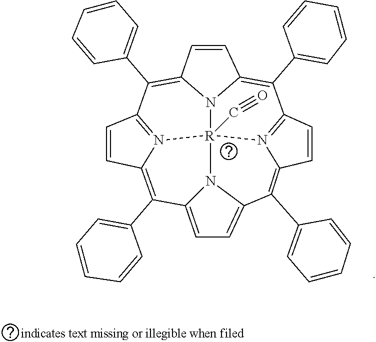

### 5. COORDINATION POLYMERS HAVING FORMULA (IV)

In some embodiments, the two-dimensional coordination polymers described herein have a structure represented by Formula (IV):

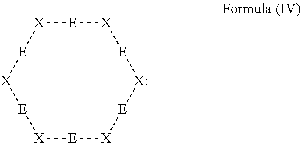

wherein:
E has a structure of

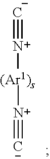

and in E, C̅≡ [symbol] indicates that the isocyano group is polar, the carbon atom tends to be negatively charged and is thus represented by C̅, and the nitrogen atom tends to be positively charged and is thus represented by [symbol] .

X has a structure of

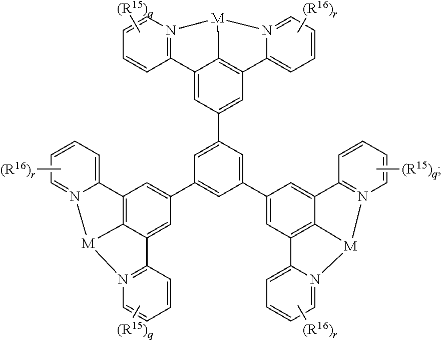

Ar¹ is unsubstituted phenyl, or phenyl substituted with one or more methyl;
R¹⁵ and R¹⁶ are each independently selected from the group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
q and r are each independently 0, 1, 2, 3, or 4;
s is an integer greater than or equal to 1 and less than or equal to 5; and
M is a metal element selected from the group consisting of Pt, Ir, Ru, Pd, Ni, Au, Cr, Co, Mo, Mn, Re, and Fe;
wherein the carbon in the isocyano in E is connected to the metal M in X via a coordination bond, as shown in the following structure:

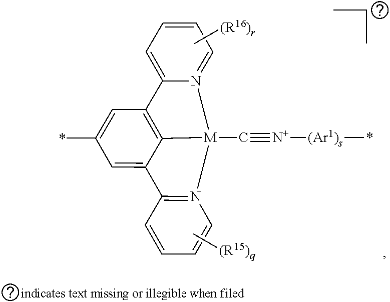

wherein * indicates a point of attachment.

In Formula (IV), “ [symbol] ” represents a coordination bond. However, the form of expression of the coordination bond is not limited to “ [symbol] ”. For example, in a specific coordination compound with the structure of Formula (IV), “- (horizontal line)” may also be used to indicate the coordination bond.

In some embodiments of Formula (IV), Ar¹ is phenyl substituted with 2 or 4 methyl,

In some embodiments of Formula (IV), s is 1 or 2.

In some embodiments of Formula (IV), R¹⁵ and R¹⁶ are each independently C₁₋₈ alkyl.

In some embodiments of Formula (IV), R¹⁵ and R¹⁶ are independently octyl.

In some embodiments of Formula (IV), q and r are independently 1 or 2.

In some embodiments of Formula (IV), M is Pt.

In some embodiments of Formula (IV), Ar¹ is phenyl substituted with 2 or 4 methyl, and s is 1.

In some embodiments of Formula (IV), R¹⁵ and R¹⁶ are independently n-octyl, q and r are independently 1, and M is Pt.

In some embodiments of Formula (IV), E is 1,4-diisocyano-2,3,5,6-tetramethyl-benzene and has a chemical structural formula of

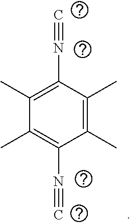

In some embodiments of Formula (IV), X is

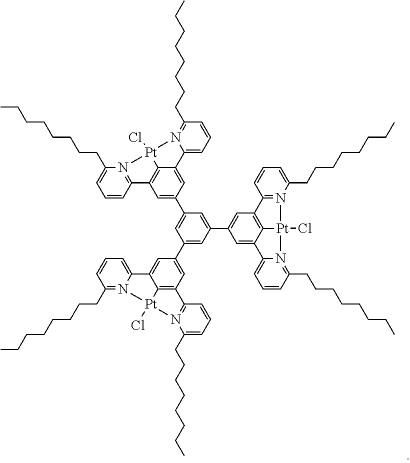

### 6. COORDINATION POLYMERS HAVING FORMULA (V)

In some embodiments, the two-dimensional coordination polymers described herein have a structure represented by Formula (V):

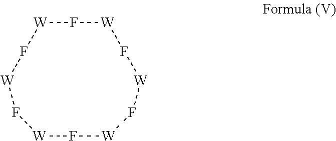

wherein:
F has a structure of

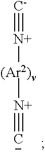

and in F, C̅≡ [symbol] indicates that the isocyano group is polar, the carbon atom tends to be negatively charged and is thus represented by C̅, and the nitrogen atom tends to be positively charged and is thus represented by [symbol] .

W has a structure of

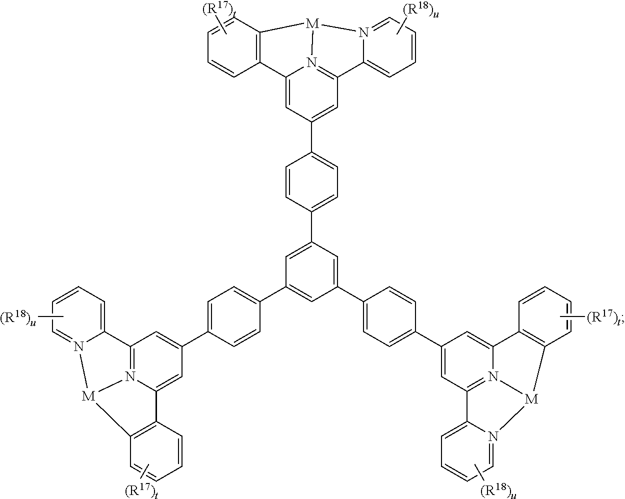

Ar² is unsubstituted phenyl, or phenyl substituted with one or more methyl;
R¹⁰ and R¹⁸ are each independently selected from the group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
t and u are each independently 0, 1, 2, 3, or 4;
v is an integer greater than or equal to 1 and less than or equal to 5;
M is a metal element selected from the group consisting of Pt, Ir, Ru, Pd, Ni, Au, Cr, Co, Mo, Mn, Re, and Fe;
wherein the carbon in the isocyano in F is connected to the metal M in W via a coordination bond, as shown in the following structure:

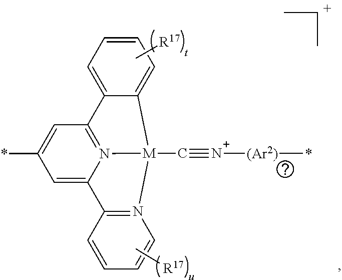

wherein * indicates a point of attachment.

In Formula (V), “ [symbol] ” represents a coordination bond. However, the form of expression of the coordination bond is not limited to “ [symbol] ”. For example, in a specific coordination compound with the structure of Formula (V), “- (horizontal line)” may also be used to indicate the coordination bond.

In some embodiments of Formula (V), Ar² is phenyl substituted with 2 or 4 methyl.

In some embodiments of Formula (V), v is 1 or 2.

In some embodiments of Formula (V), R¹⁰ and R¹⁸ are C₁₋₈ alkyl.

In some embodiments of Formula (V), R¹⁰ and R¹⁸ are independently pentyl.

In some embodiments of Formula (V), u and t are independently 0, 1, or 2.

In some embodiments of Formula (V), M is Pt.

In some embodiments of Formula (V), Ar² is phenyl substituted with 2 or 4 methyl, and v is 1.

In some embodiments of Formula (V), R¹⁰ is isopentyl, t is 1, and u is 0.

In some embodiments of Formula (V), F is 1,4-diisocyano-2,3,5,6-tetramethyl-benzene and has a chemical structural formula of

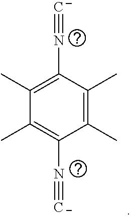

In some embodiments of Formula (V), W is

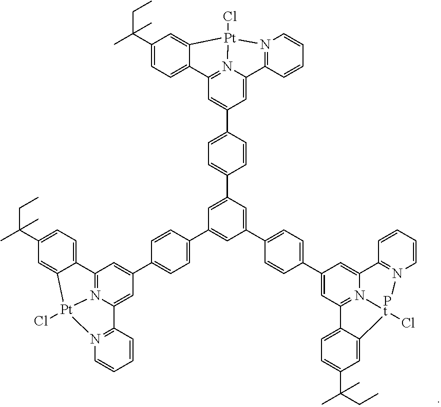

### 7. SYNTHESIS EXAMPLES

These examples illustrate the preparation of two-dimensional coordination polymers having Formula (I), Formula (II), Formula (III), Formula (IV) or Formula (V) as described above.

### Synthesis Example 1

This example illustrated the preparation of a two-dimensional coordination polymer having Formula (I).

### (a) Preparation of 4,4′-diisocyano-3,3′,5,5′-tetramethyl-1,1′-biphenyl (iCN-2)

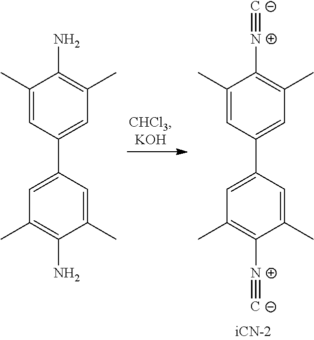

3,3′,5,5′-tetramethyl-[1,1′-biphenyl]-4,4′-diamine (2.00 g, 8.32 mmol) was dissolved in 200 mL of CH₂Cl₂. Then, benzyltriethylammonium chloride (10.47 mg) was added. While stirring the solution, 200 mL of a potassium hydroxide solution with a mass concentration of 45% was added slowly in 5 min, forming a biphasic mixture. Chloroform (2.20 g, 18.39 mmol) was added to the biphasic mixture, and the reaction mixture was heated to 80° C. and refluxed for 12 hours. The color of the reaction mixture changed to deep red. After cooling to room temperature, the mixture was transferred to a separatory flask, diluted with 400 mL of distilled water, and extracted twice with distilled water and once with saturated sodium chloride. After removal of the aqueous phase, the organic phase was dried over anhydrous magnesium sulfate, filtered, and evaporated to remove the solvent to obtain an orange solid. The orange solid was then purified by chromatography to give 4,4′-diisocyano-3,3′,5,5′-tetramethyl-1,1′-biphenyl (abbreviated as iCN-2, 1.05 g, yield 48%) as a yellow solid.

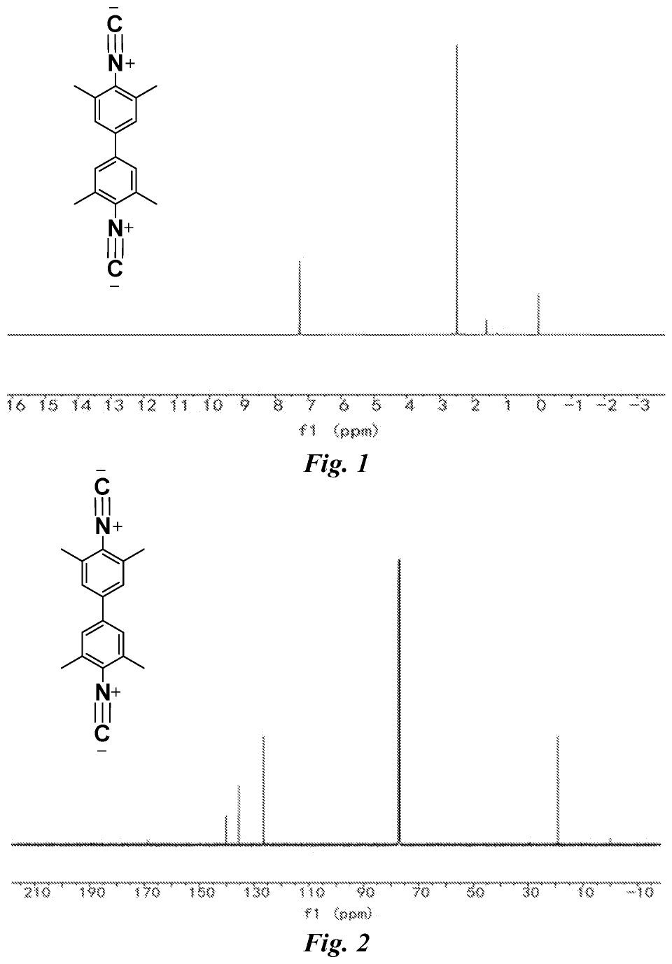

FIG. 1 was a hydrogen nuclear magnetic resonance spectrum of iCN-2, and the characterization data in the figure were as follows: ¹H NMR (CDCl₃, 500 MHz) δ [ppm]: 2.46 (s, 12H, CH₃), 7.25 (s, 4H, ArH). FIG. 2 was a carbon nuclear magnetic resonance spectrum of iCN-2, and the characterization data in the figure were as follows: ¹³C NMR (CDCl₃, 500 MHz) δ [ppm]: 19.31, 126.72, 135.68, 140.35, 169.02.

### (b) Preparation of mEML-2-LL

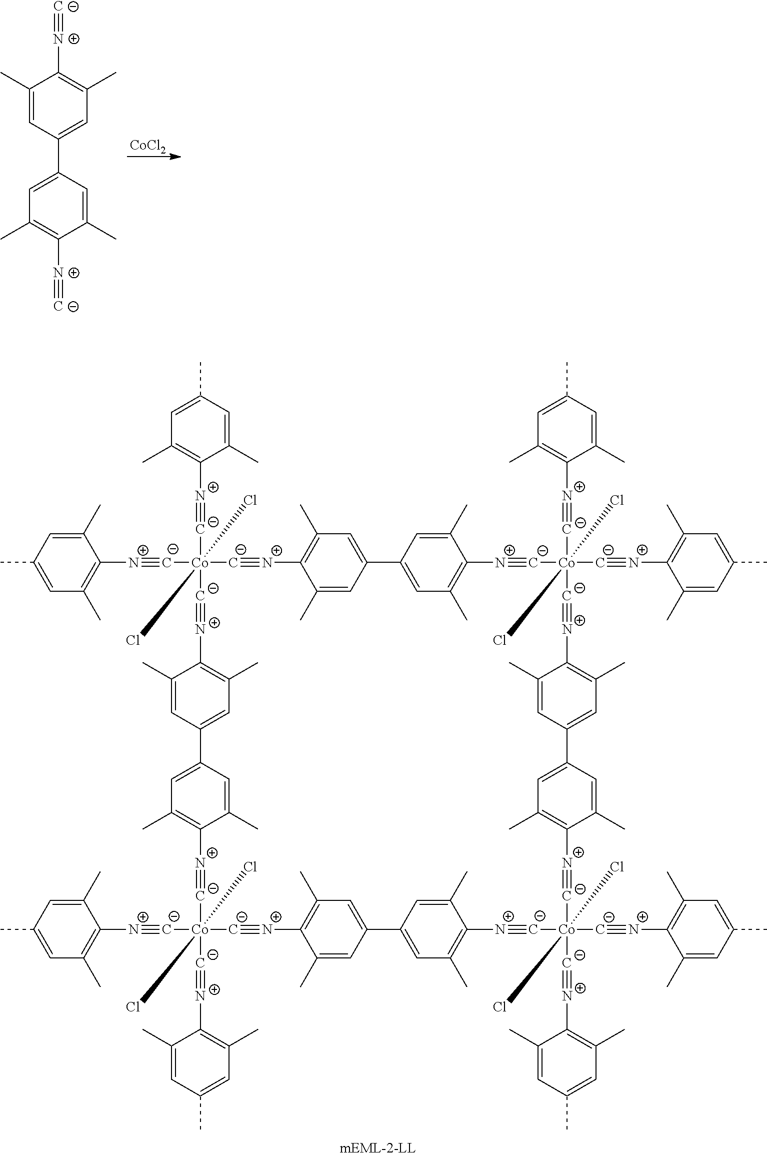

iCN-2 (65 mg, 0.025 mmol) was dissolved in 25 mL of chloroform (0.01 mol/L) and was added to a reaction flask. Then, 25 mL of the solution of CoCl₂ (0.5 mol/L) was added to form an oil-water interface (i.e. chloroform-water interface). Formation of film can be observed at the chloroform-water interface. This film is namely the two-dimensional coordination polymer mEML-2-LL.

### Synthesis Example 2

This example illustrated the preparation of a two-dimensional coordination polymer having Formula (II).

### (a) Preparation of 1-bromo-2,3,5,6-tetramethyl-4-nitrobenzene (Compound 2)

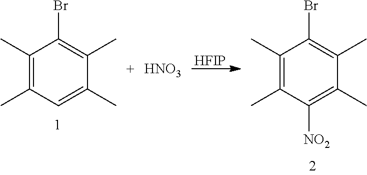

Concentrated nitric acid (>90%, 800 L) was dissolved in 1,1,1,3,3,3-hexafluoroisopropanol (HFIP, 8.0 mL) and placed in a 50 mL round-bottomed flask with a PTFE stirring bar. 1-Bromo-2,3,5,6-tetramethylbenzene (Compound 1, 3.41 g, 16.00 mmol) was added quickly to the above solution, and kept at 0° C. in ice-bath with continuous stirring for 30 min. Then, after stirring at room temperature for 2 h, the solvent was removed under reduced pressure to obtain a crude product. The crude product was then purified by column chromatography to afford Compound 2 as a white solid (2.28 g, 8.83 mmol, yield: 55%).

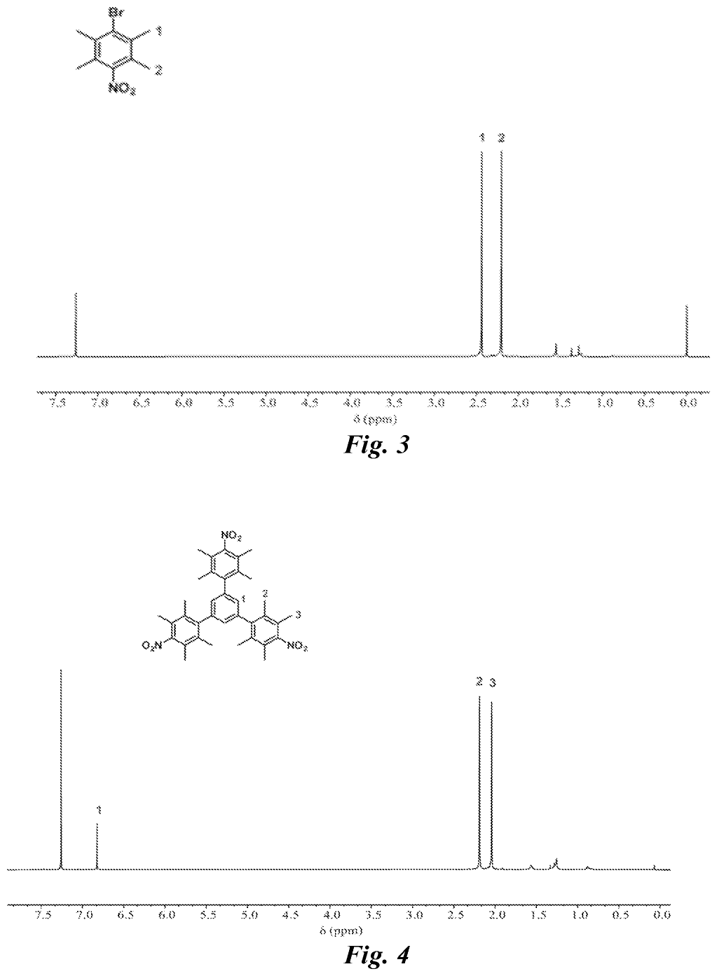

FIG. 3 was a hydrogen nuclear magnetic resonance spectrum of 1-bromo-2,3,5,6-tetramethyl-4-nitrobenzene (Compound 2), and the characterization data in the figure were as follows: ¹H NMR (CDCl₃, 500 MHz, ppm): δ 2.44 (s, 1H), 2.20 (s, 1H). In addition, Compound 2 was also detected by mass spectrometry, and the characterization data were as follows: GC-MS (m/z): calculated for C₁₀H₁₂BrNO₂ [M]⁺: 257.01, and found: 257.07.

### (b) Preparation of 1,3,5-tris(2,3,5,6-tetramethyl-4-nitrophenyl)benzene (Compound 3)

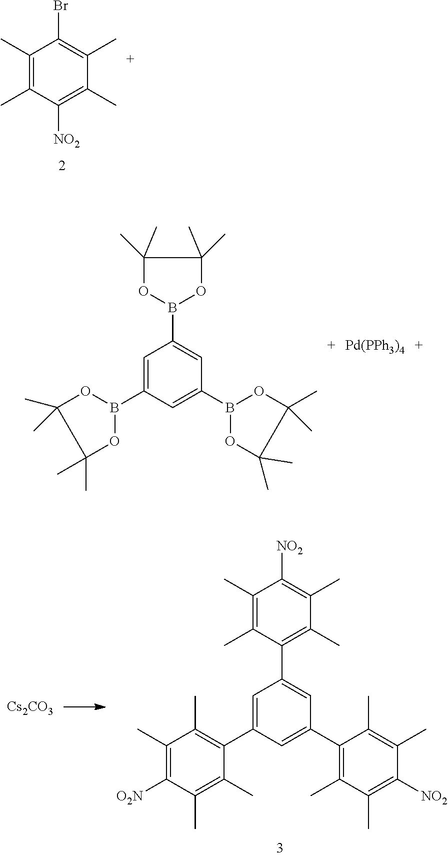

Compound 2 (1.60 g, 6.20 mmol), 1,3,5-tris(4,4,5,5-tetramethyl-1,3,2-dioxaborolan yl)benzene (706.7 mg, 1.55 mmol), Pd(PPh₃)₄ (358.2 mg, 0.41 mmol) and cesium carbonate (4.04 g, 12.40 mmol) were placed in a 250 mL three-necked flask. After three freeze-pump-thaw cycles, pre-degassed 1,4-dioxane (50 mL) and H₂O (10 mL) were added. The mixture was heated at 90° C. for 20 h under nitrogen atmosphere. After cooling to room temperature, the reaction was terminated by adding water and ethyl acetate (EA). Then, the crude product was extracted with ethyl acetate several times. After removing the organic solvent under reduced pressure, a crude product was obtained, and the crude product was purified by column chromatography to afford Compound 3 as a white solid (250.0 mg, 0.41 mmol, yield: 27%).

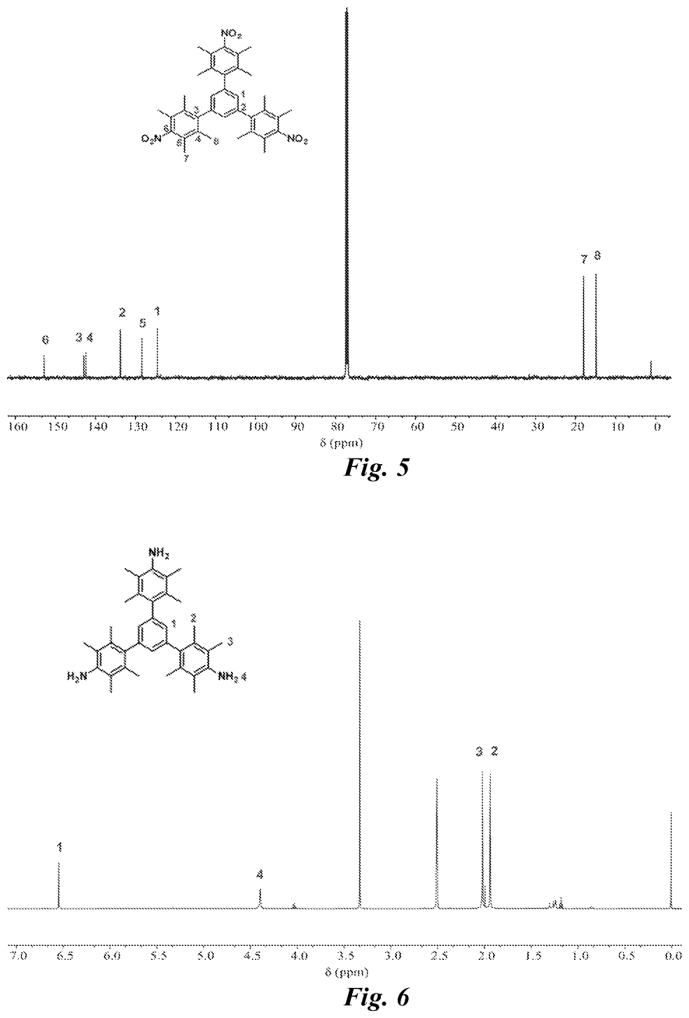

FIG. 4 was a hydrogen nuclear magnetic resonance spectrum of 1,3,5-tris(2,3,5,6-tetramethyl-4-nitrophenyl)benzene (Compound 3), and the characterization data in the figure were as follows: ¹H NMR (CDCl₃, 500 MHz, ppm): δ 6.82 (s, 1H), 2.19 (s, 6H), 2.04 (s, 6H). FIG. 5 was a carbon nuclear magnetic resonance spectrum of 1,3,5-tris(2,3,5,6-tetramethyl-4-nitrophenyl)benzene (Compound 3), and the characterization data in the figure were as follows: ¹³C NMR (CDCl₃, 126 MHz, ppm): δ 152.85, 142.87, 142.38, 133.75, 128.41, 124.54, 18.01, 14.90.

### (c) Preparation of 1,3,5-tris(2,3,5,6-tetramethyl-4-aminophenyl)benzene (Compound 4)

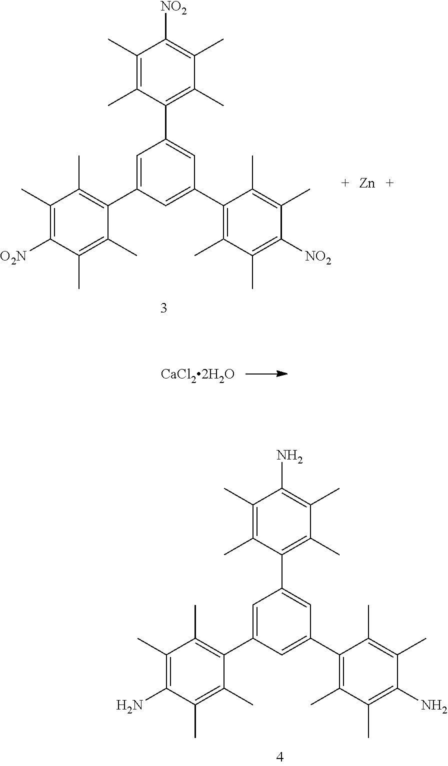

Compound 3 (1.00 g, 1.64 mmol) was dispersed in a mixed solvent of ethanol/water (25 mL/6.6 mL), and CaCl₂.2H₂O (0.50 g, 3.40 mmol) and zinc powder (1.39 g, 21.32 mmol) were then added. The mixture was vigorously stirred at 75° C. for 24 h. After cooling to room temperature, the mixture was filtered through Celite, and the obtained solid was washed with ethanol several times. After removing the solvent under reduced pressure, the obtained solid product was dried under reduced pressure to obtain Compound 4 (0.80 g, yield: 94%) as a light yellow solid.

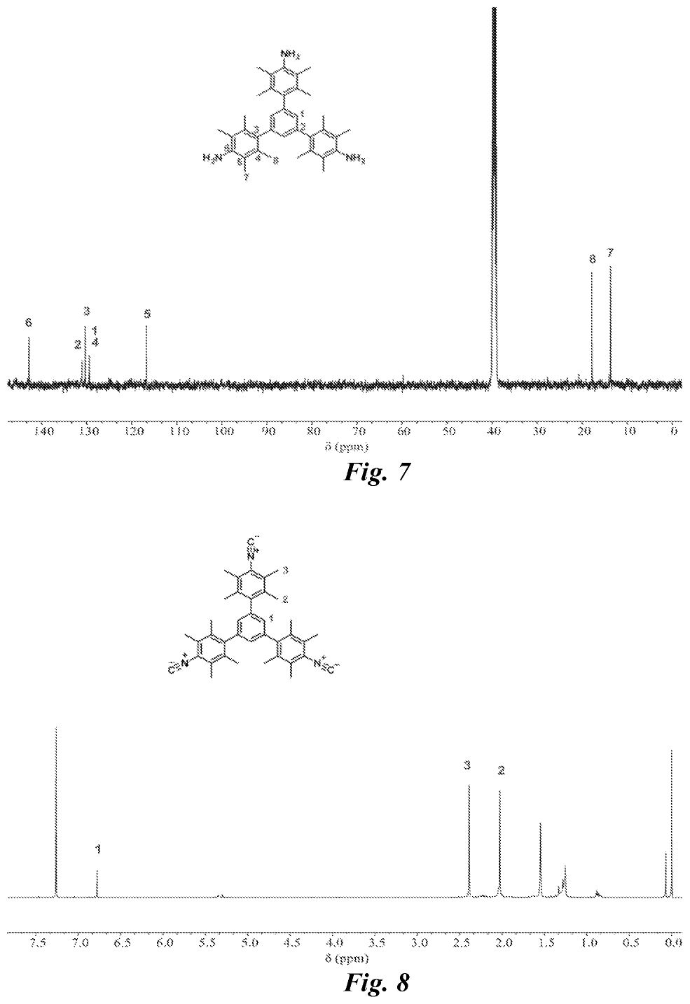

FIG. 6 was a hydrogen nuclear magnetic resonance spectrum of 1,3,5-tris(2,3,5,6-tetramethyl-4-aminophenyl)benzene (Compound 4), and the characterization data in the figure were as follows: ¹H NMR (DMSO-d₆, 500 MHz, ppm): δ 6.55 (s, 1H), 4.40 (s, 2H), 2.02 (s, 6H), 1.94 (s, 6H). FIG. 7 was a carbon nuclear magnetic resonance spectrum of 1,3,5-tris(2,3,5,6-tetramethyl-4-aminophenyl)benzene (Compound 4), and the characterization data in the figure were as follows: ¹³C NMR (DMSO-d₆, 126 MHz, ppm): δ 142.83, 131.04, 130.30, 129.43, 116.74, 17.88, 13.71.

### (d) Preparation of 1,3,5-tris(2,3,5,6-tetramethyl-4-isocyanophenyl)benzene (iCTB)

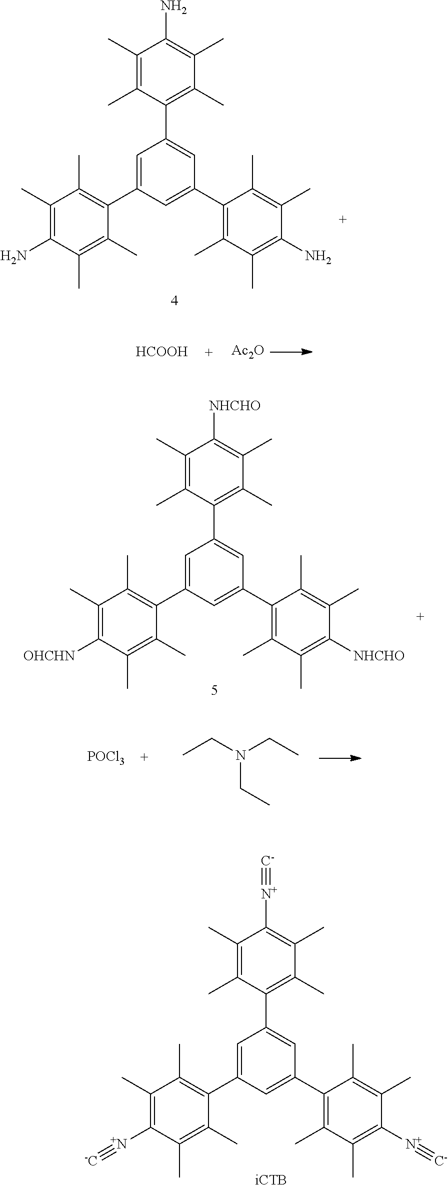

A mixed solution of formic acid (1.7 mL, 44.95 mmol) and acetic anhydride (3.0 mL, 31.71 mmol) was heated at 70° C. for 2 h. Then, Compound 4 (0.70 g, 1.35 mmol) was dissolved in tetrahydrofuran (THF, 8.0 mL) and added dropwise to the above mixed solution under ice bath condition. After stirring at room temperature for 3 h, the solvent was removed under reduced pressure to give the intermediate product, Compound 5. Subsequently, triethylamine (12.3 mL, 88.48 mmol) and CH₂Cl₂ (30 mL) were added to produce a suspension of Compound 5. Phosphorous oxychloride (POCl₃, 0.53 mL, 5.66 mmol) was added dropwise to the above suspension. After stirring for 2 h at room temperature, the reaction mixture was neutralized with saturated NaHCO₃ solution and the two-phase mixture was stirred for 0.5 h. After separation, an aqueous phase was obtained, and the aqueous phase was extracted with CH₂Cl₂. The CH₂Cl₂ extraction liquid was collected, and the organic solvent was removed under reduced pressure to give a crude product. Subsequently, the crude product was purified by column chromatography to afford 1,3,5-tris(2,3,5,6-tetramethyl-4-isocyanophenyl)benzene (denoted as iCTB, 0.18 g, 0.33 mmol, yield: 24%).

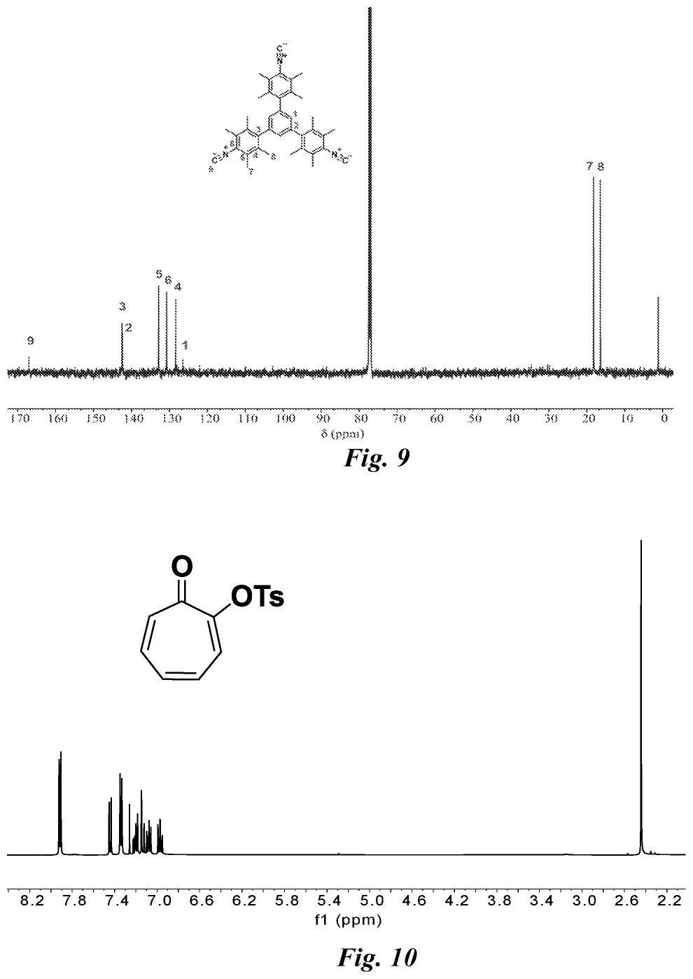

FIG. 8 was a hydrogen nuclear magnetic resonance spectrum of 1,3,5-tris(2,3,5,6-tetramethyl-4-isocyanophenyl)benzene (iCTB), and the characterization data in the figure were as follows: ¹H NMR (CDCl₃, 500 MHz, ppm): δ 6.78 (s, 1H), 2.39 (s, 6H), 2.03 (s, 6H). FIG. 9 was a carbon nuclear magnetic resonance spectrum of 1,3,5-tris(2,3,5,6-tetramethyl-4-isocyanophenyl)benzene (iCTB), and the characterization data in the figure were as follows: ¹³C NMR (CDCl₃, 126 MHz, ppm): δ 167.02, 142.49, 142.31, 132.83, 130.76, 128.32, 126.48, 18.23, 16.42.

### (e) Preparation of PiCTB

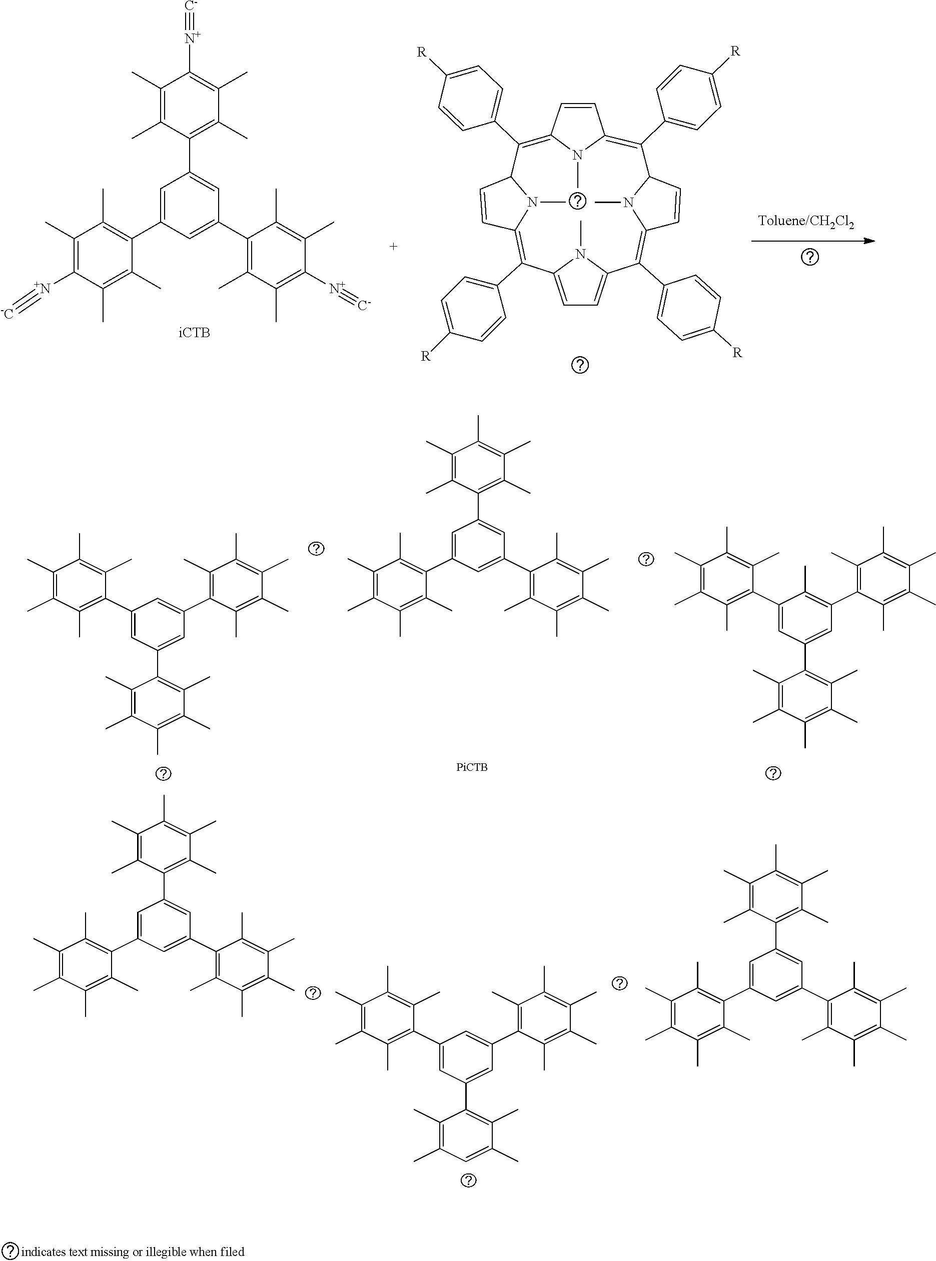

Under argon atmosphere, iCTB (10.0 mg, 18.70 μmol) was added to a mixed solvent of toluene/CH₂Cl₂ (10 mL/10 mL), and RuPor (20.8 mg, 28.00 μmol) was then added to obtain a mixed solution. The mixed solution was stirred for 24 h at room temperature. Formation of precipitate could be observed and the precipitate was then collected by centrifugation. After washing twice with CH₂Cl₂, the precipitate was vacuum dried, an isocyanide-based coordination two-dimensional polymer PiCTB powder (15.0 mg, yield: 49%) was received.

The chemical formula of RuPor was

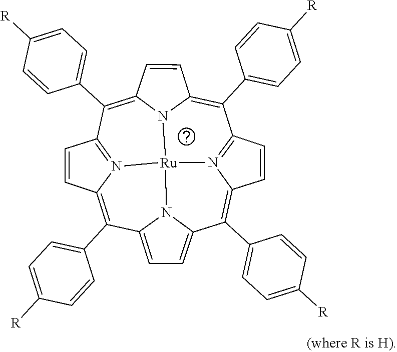

### Synthesis Example 3

This example illustrated the preparation of a two-dimensional coordination polymer having Formula (III).

### (a) Preparation of 7-oxocyclohepta-1,3,5-trienyl 4-methylbenzenesulfonate (Compound 6)

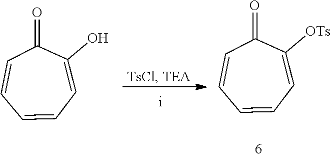 [SMILES: O=c1cccccc1O ; Cc1ccc(S(=O)(=O)Oc2cccccc2=O)cc1]

A round-bottomed flask was charged with 2-hydroxycyclohepta-2,4,6-trienone (tropolone, 10.6 g, 86 mmol) and 4-methylbenzene-1-sulfonyl chloride (TsCl, 16.4 g, 86 mmol). Then, CH₂Cl₂ (120 mL) was added into the flask at room temperature. After stirring for 5 min, triethylamine (TEA, 12 mL, 86 mmol) was added dropwise to the mixture. After a yellow slurry appeared, another 120 mL of CH₂Cl₂ was added because of increased viscosity of the reaction mixture. Then, the mixture was stirred at room temperature for 32 h under nitrogen protection, and the reaction was quenched with 250 mL deionized water. Then, the mixture was extracted with CH₂Cl₂. The CH₂Cl₂ extraction liquid was collected and dried using MgSO₄ for 15 min. After filtration, the organic solvent was removed under reduced pressure to yield compound 6 (23.5 g, yield: 98%) as a tan-colored solid. The tan-colored solid was used for the next step without further purification.

FIG. 10 was a hydrogen nuclear magnetic resonance spectrum of 7-oxocyclohepta-1,3,5-trienyl 4-methylbenzenesulfonate (Compound 6), and the characterization data in the figure were as follows: 1H NMR (CDCl₃, 500 MHz, ppm): δ 2.44 (s, 3H), 6.97 (t, 1H), 7.08 (t, 1H), 7.15 (d, 1H), 7.20 (m, 1H), 7.33 (d, 2H), 7.45 (d, 1H), 7.91 (d, 2H).

### (b) Preparation of 2-amino-1,3-diethoxycarbonyl azulene (Compound 7)

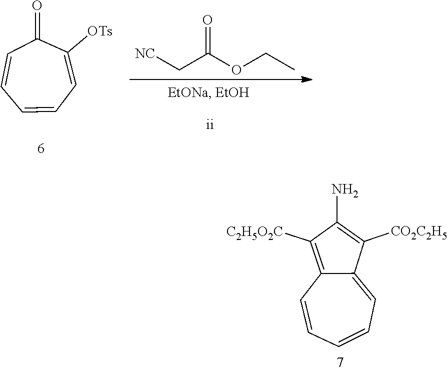

Compound 6 (11.8 g, 43 mmol) and ethyl cyanoacetate (9.7 g 86 mmol) were transferred into flask A. Sodium ethoxide (5.8 g, 86 mmol) was quickly transferred into flask B. Then, 50 mL of ethanol (EtOH) was added to the flask B to dissolve sodium ethoxide. The flask A was cooled to 0° C. by immersing into an ice water bath, and the content of the flask B was added to the flask A dropwise through a syringe over 15 min. The mixture was stirred at 0° C. for 6 h, and then slowly warmed to room temperature overnight. Then, deionized water (100 mL) was poured into the mixture. The resulting yellow suspension was extracted with CH₂Cl₂ several times. The CH₂Cl₂ extraction liquids were combined, dried and evaporated to give a crude product as an orange solid. The crude product was purified by chromatography to yield Compound 7 as yellow solid (10.4 g, yield: 85%).

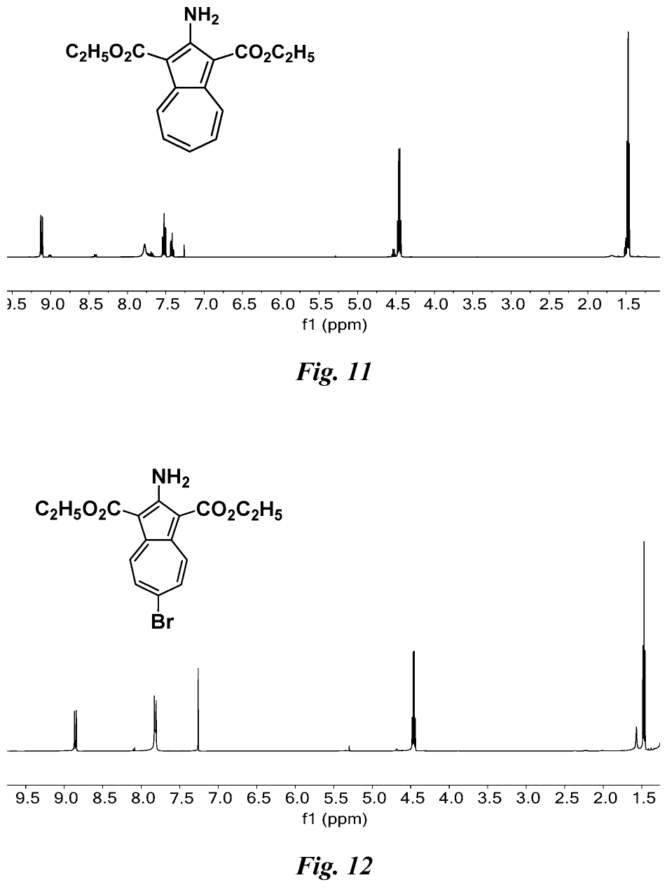

FIG. 11 was a hydrogen nuclear magnetic resonance spectrum of 2-amino-1,3-diethoxycarbonyl azulene (Compound 7), and the characterization data in the figure were as follows: ¹H NMR (CDCl₃, 500 MHz, ppm): δ 1.47 (t, 6H), 4.46 (q, 4H), 7.42 (t, 1H), 7.52 (t, 2H), 7.77 (s, 2H), 9.13 (d, 2H).

### (c) Preparation of 2-amino-6-bromo-1,3-diethoxycarbonyl azulene (Compound 8)

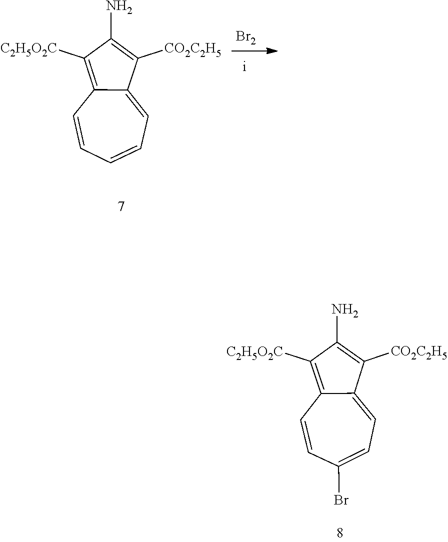

Compound 7 was placed in a reaction flask, the reaction flask was placed in a chilled (0° C.) solution in 250 mL of CH₂Cl₂, bromine (3.84 g, 24.0 mmol) was added dropwise to Compound 7 (6.9 g, 24.0 mmol) under vigorous stirring, and the mixture was left to stand in the chilled (0° C.) solution in CH₂Cl₂ for 20 min. The ice bath was then removed, and the reaction mixture was allowed to warm to room temperature. The mixture was stirred for 1.5 h and then poured into 500 mL of distilled water. After extraction with CH₂Cl₂ several times, the CH₂Cl₂ organic extraction liquids were combined and dried over MgSO₄. Filtration followed by solvent removal under vacuum provided a dark crude product. The crude product was purified by column chromatography to yield Compound 8 (6.24 g, yield: 71%) as an orange powder.

FIG. 12 was a hydrogen nuclear magnetic resonance spectrum of 2-amino-6-bromo-1,3-diethoxycarbonyl azulene (Compound 8), and the characterization data in the figure were as follows: ¹H NMR (CDCl₃, 500 MHz, ppm): δ 1.46 (t, 6H), 4.45 (q, 4H), 7.81 (d, 2H), 7.82 (s, 2H), 8.84 (d, 2H).

### (d) Preparation of hexaethyl 6,6′,6″-(benzene-1,3,5-triyl)tris(2-aminoazulene-1,3-dicarboxylate) (Compound 9)

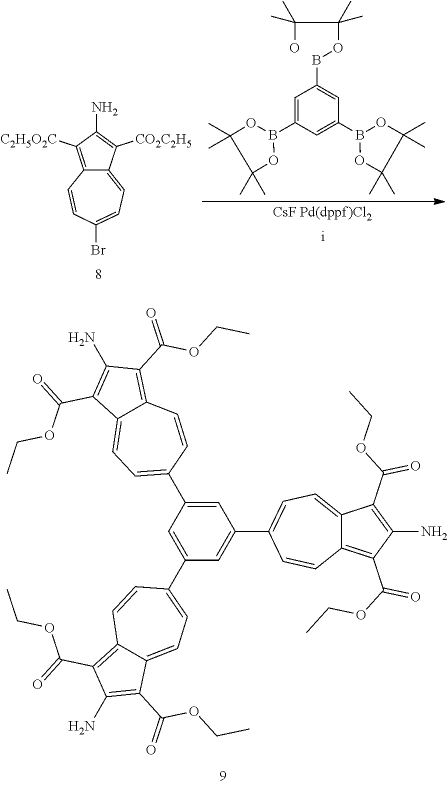

1,3,5-Tris(4,4,5,5-tetramethyl-1,3,2-dioxaborolan-2-yl)benzene (0.79 g, 1.73 mmol) and Compound 8 (2.15 g, 5.88 mmol) were dissolved in a mixed solvent of dioxane/H₂O (24 mL/24 mL), which was deoxygenated by three freeze-pump-thaw cycles and protected under nitrogen atmosphere. After quick addition of CsF (2.40 g, 15.7 mmol) and Pd(dppf)Cl₂ (0.095 g, 0.13 mmol), the suspension was heated and stirred vigorously at 90° C. for 24 h. After cooling down to room temperature, the resulting suspension was charged with an NH₄Cl solution with a mass concentration of 20% and cleaned with CH₂Cl₂ (DCM) to yield Compound 9 (630 mg, yield: 78%) as a yellow powder. The yellow powder product was directly used for next step without further purification.

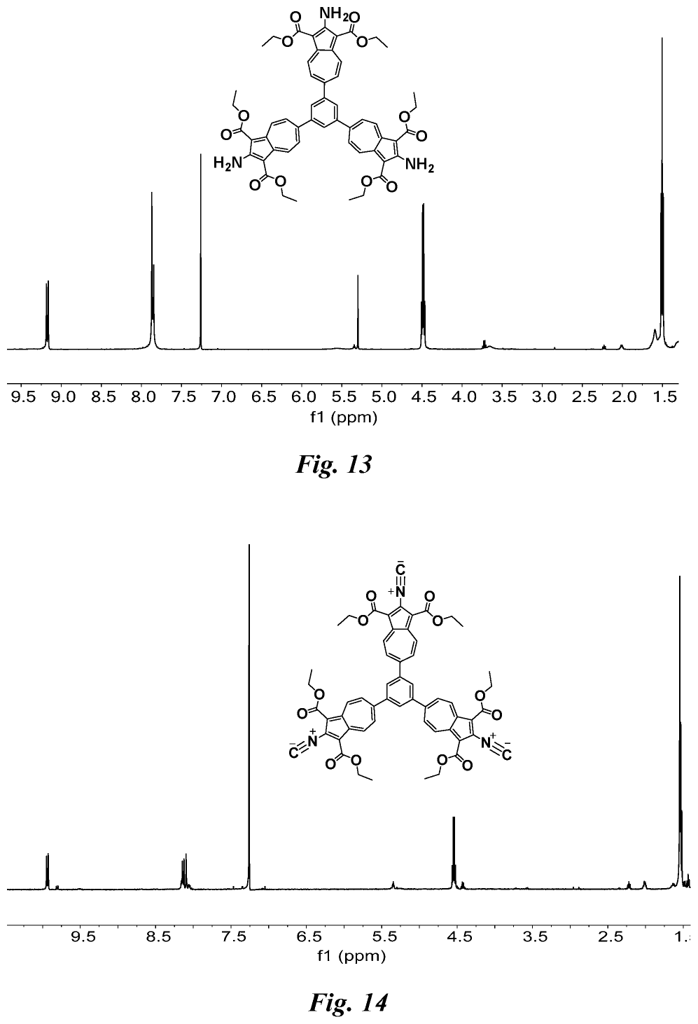

FIG. 13 was a hydrogen nuclear magnetic resonance spectrum of hexaethyl 6,6′,6″-(benzene-1,3,5-triyl)tris(2-aminoazulene-1,3-dicarboxylate) (Compound 9), and the characterization data in the figure were as follows: ¹H NMR (CDCl₃, 500 MHz, ppm): δ 1.50 (t, 18H), 4.49 (q, 12H), 7.87 (m, 15H), 9.16 (d, 6H).

### (e) Preparation of hexaethyl 6,6′,6″-(benzene-1,3,5-triyl)tris(2-isocyanoazulene-1,3-dicarboxylate) (iCTA)

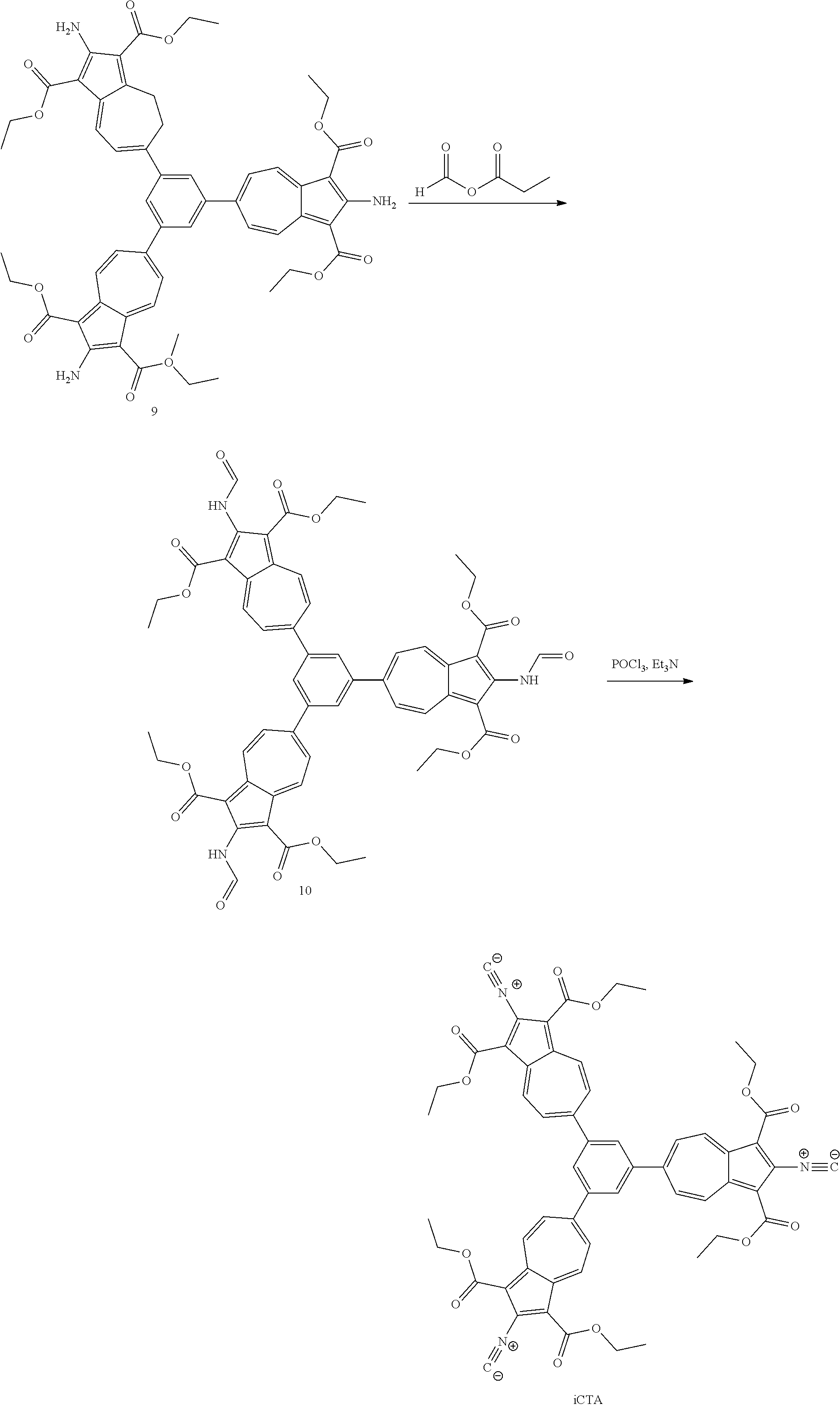

A mixture of acetic anhydride (9.9 mL, 0.105 mol) and formic acid (7.92 mL, 0.21 mol) was heated at 60° C. for 2.5 h with stirring. To the resulting in-situ formed acetic-formic anhydride, Compound 9 (0.65 g, 0.70 mmol) was added, along with additional formic acid (7.92 mL, 0.21 mol). The dark red mixture was stirred at 60° C. for 18 h. The mixture was cooled to room temperature, the reaction was quenched with aqueous Na₂CO₃ with a mass concentration of 10%, and the mixed liquid was then extracted with CH₂Cl₂. The CH₂Cl₂ extraction liquids were combined, washed with water, and then dried over anhydrous magnesium sulfate. The solution was filtered to remove the drying agent and the filtrate was concentrated on a rotary evaporator. Addition of hexane to the concentrated solution precipitated an orange solid, which was filtered off and dried in a vacuum oven to afford Compound 10. Neat POCl₃ (0.16 ml, 1.72 mmol) was added slowly to Compound 10 got before and trimethylamine (5.3 mL, 38.56 mmol) under nitrogen atmosphere. 10 mL of CH₂Cl₂ was added. The resulting mixture was stirred for 1 h, and the reaction was then quenched with 100 mL of an Na₂CO₃ solution with a mass concentration of 10%. The organic phase was separated and the aqueous phase was extracted with CH₂Cl₂ several times. The CH₂Cl₂ extraction liquids were combined, washed with H₂O, and dried over anhydrous MgSO₄. The solution was filtered to remove the drying agent and the filtrate was concentrated on a rotary evaporator to obtain a crude product. The crude product was purified by column chromatography to yield hexaethyl 6,6′,6″-(benzene-1,3,5-triyl)tris(2-isocyanoazulene-1,3-dicarboxylate) (abbreviated as iCTA, 116 mg, yield: 17%) as a lavender powder.

FIG. 14 was a hydrogen nuclear magnetic resonance spectrum of 1,3,5-tris[2-isocyano-1,3-diethoxycarbonylazulen-6-yl]benzene (iCTA), and the characterization data in the figure were as follows: ¹H NMR (CDCl₃, 500 MHz, ppm): δ 1.55 (t, 18H), 4.54 (q, 12H), 8.10 (s, 3H), 8.12 (d, 6H), 9.93 (d, 6H).

### (f) Preparation of PiCTA

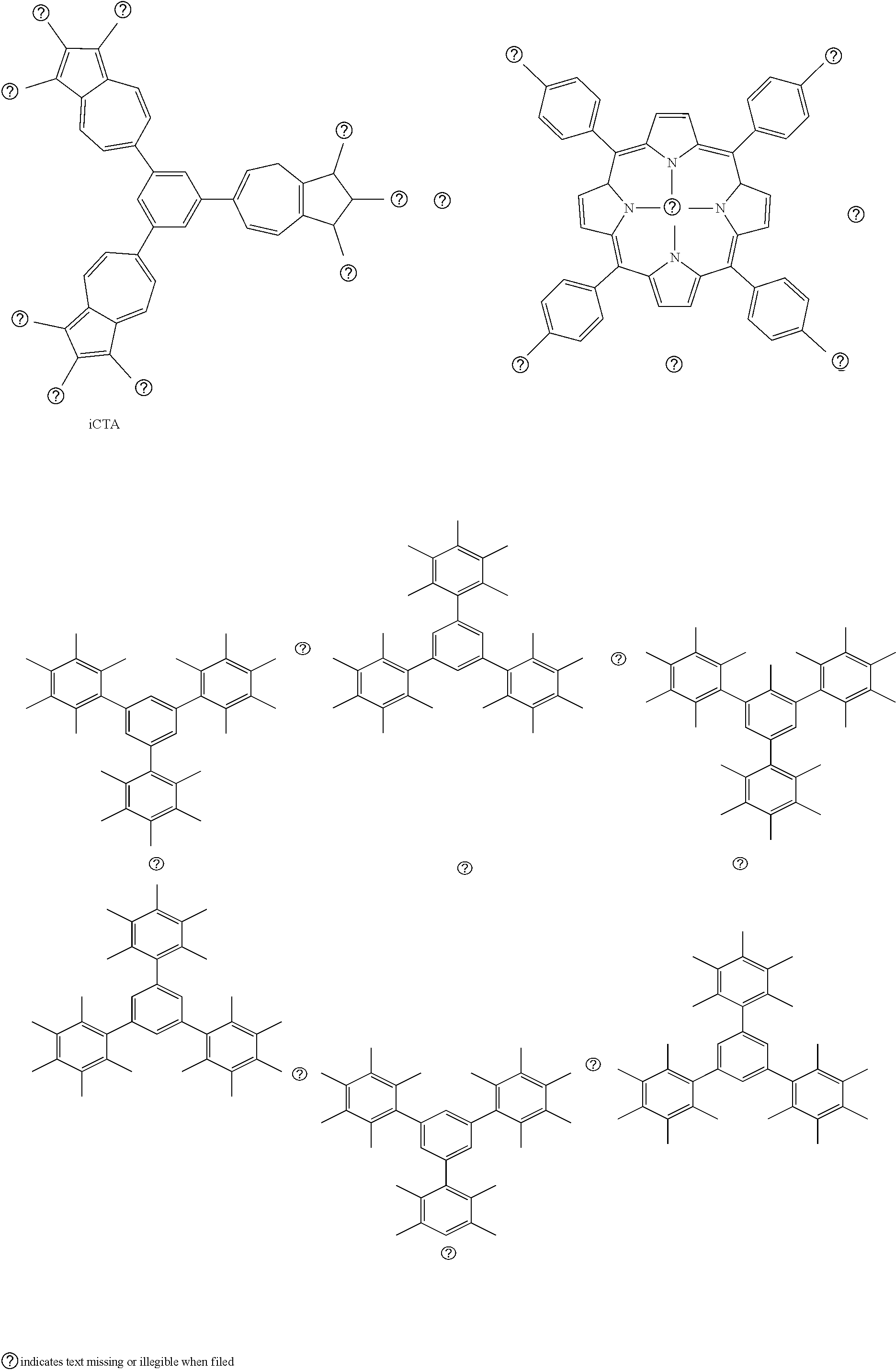

Under argon atmosphere, iCTA (10.0 mg, 10.37 μmol) was added to a mixed solvent of toluene/chloroform (10 mL/10 mL), and RuPor (11.5 mg, 15.56 μmol) was then added to obtain a mixed solution. The mixed solution was stirred for 24 h at room temperature. Precipitation could be observed and the precipitate was then collected by centrifugation. After washing twice with CH₂Cl₂, the precipitate was vacuum dried, an isocyanide-based coordination two-dimensional polymer PiCTA powder (10.1 mg, yield: 47%) was received.

The chemical formula of RuPor was (where R is H).

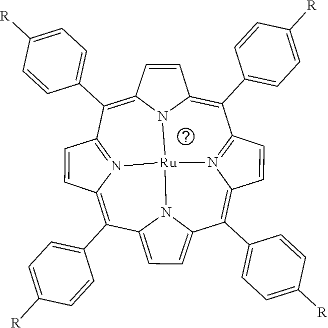

### Synthesis Example 4

This example illustrated the preparation of a two-dimensional coordination polymer having Formula (IV).

### (a) Preparation of 2-bromo-6-octylpyridine (Compound 11)

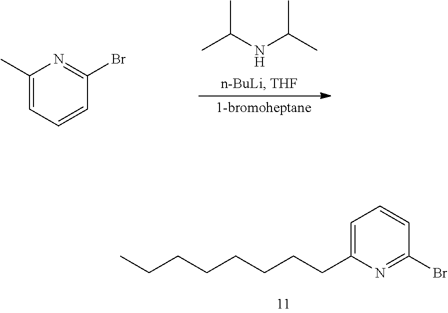

In a dried Schlenk tube equipped with a magnetic stirring bar, diisopropyl amine (33 mmol) was dissolved in anhydrous THF (73 mL) and cooled to −78° C. Then, 1.6 M n-butyl lithium in hexane (20.6 mL, 33 mmol) was added dropwise to the mixed solution and the mixed solution was stirred at −78° C. for 30 min. A solution of 2-bromo-6-methylpyridine (30 mmol) in anhydrous THF (73 mL) was added to the above mixed solution at −78° C. over 10 min. After 30 min, 1-bromoheptane (45 mmol) was added dropwise to the reaction mixture solution and the mixed solution was allowed to warm to room temperature. After full consumption of the starting material was indicated by thin layer chromatography (1-2 h), the reaction was quenched with sat. aq. NH₄Cl solution (50 mL). After most of the solvent was evaporated under reduced pressure, extraction was carried out with ethyl acetate (EtOAc, 40 mL) three times. The EtOAc extracts were combined, subsequently washed with sat. aq. NaHCO₃ solution and brine and dried over MgSO₄. After removal of the solvent under reduced pressure, a crude product was obtained, and the crude product was purified by flash column chromatography (silica, n-pentane/EtOAc 99:1 to 49:1) to afford Compound 11 as a yellowish oil, with a yield of 85%.

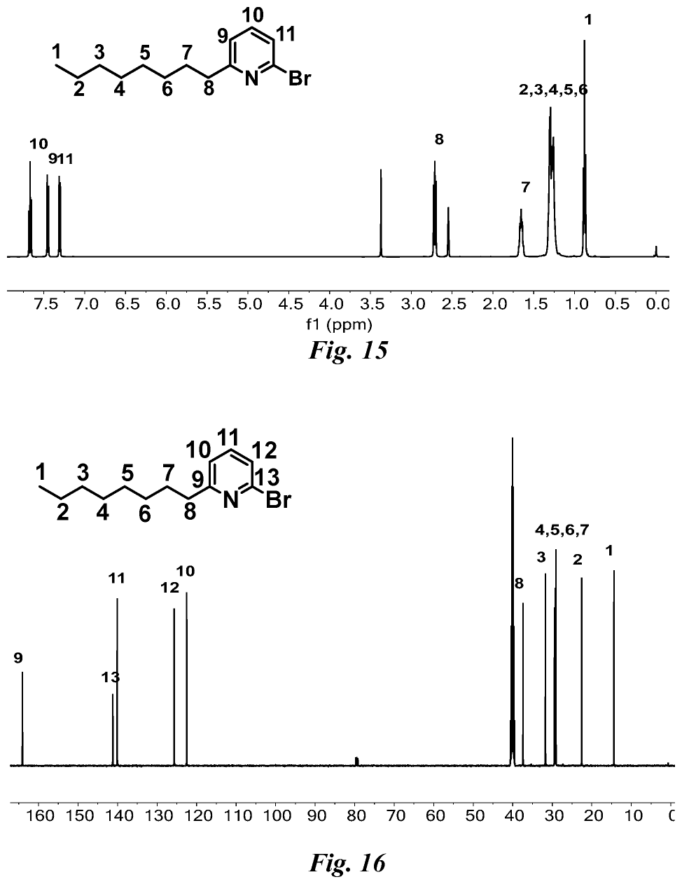

FIG. 15 was a hydrogen nuclear magnetic resonance spectrum of 2-bromo-6-octylpyridine (Compound 11), and the characterization data in the figure were as follows: ¹H NMR (500 MHz, DMSO-d₆) δ 7.67 (t, J=7.7 Hz, 1H), 7.45 (d, J=7.8 Hz, 1H), 7.31 (d, J=7.6 Hz, 1H), 2.80-2.65 (m, 2H), 1.65 (t, J=7.4 Hz, 2H), 1.33-1.22 (m, 10H), 0.88 (t, J=6.8 Hz, 3H). FIG. 16 was a carbon nuclear magnetic resonance spectrum of 2-bromo-6-octylpyridine (Compound 11), and the characterization data in the figure were as follows: ¹³C NMR (126 MHz, DMSO-d₆) δ 164.07, 141.20, 140.08, 125.67, 122.50, 37.40, 31.73, 29.43, 29.25, 29.09, 29.08, 22.56, 14.38.

### (b) Preparation of 6,6′-(5-bromo-1,3-phenylene)bis(2-octylpyridine) (Compound 12)

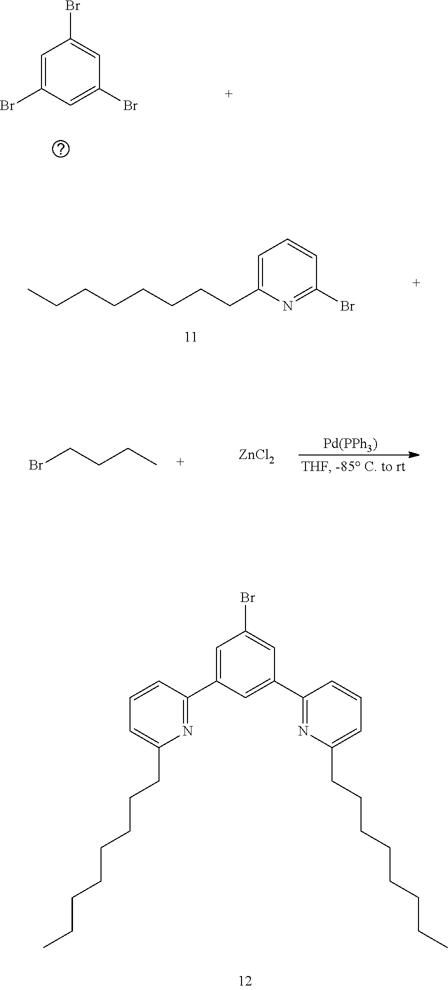

A 1.6 M of n-butyl lithium solution in hexane (30.0 mL) was added to the solution of Compound 11 (47.7 mmol) in THF (150 mL) at −86° C. and stirred for 2 h. To this solution was added a solution of ZnCl₂ (6.50 g, 47.7 mmol) in THF (63 mL) at −86° C. and the resulting mixture was stirred for 2 h at room temperature. Then, a solution of 1,3,5-tribromobenzene (m-3Br-Ph, 23.9 mmol) and Pd(PPh₃)₄ (1.65 g, 1.43 mmol) in THF (30 mL) was added to the above system and the mixture was stirred at room temperature for 24 h. Brine (150 mL) was added and the organic phase was extracted three times with EtOAc (200 mL) and the organic phases of EtOAc extraction were combined and washed once with brine (200 mL). The organic phase was dried over MgSO₄, and concentrated in vacuo to obtain a crude product. The crude product was purified by silica gel column chromatography with hexane:EtOAc (2:1, v/v) to afford Compound 12 as a yellow oil, with a yield of 55%.

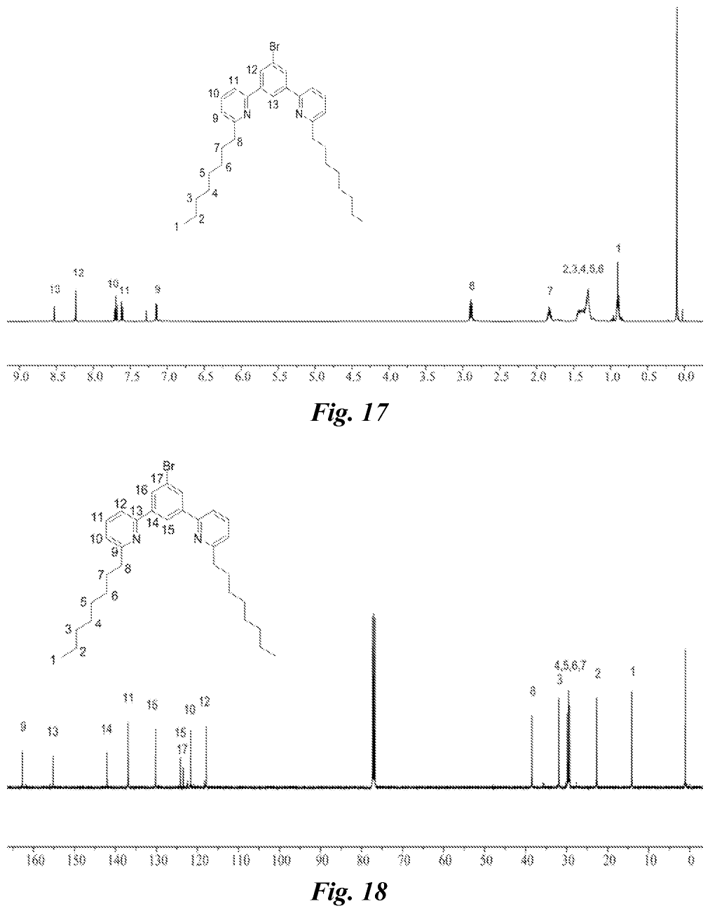

FIG. 17 was a hydrogen nuclear magnetic resonance spectrum of 6,6′-(5-bromo-1,3-phenylene)bis(2-octylpyridine) (Compound 12), and the characterization data in the figure were as follows: 1H NMR (500 MHz, Chloroform-d) δ 8.53 (t, J=1.6 Hz, 1H), 8.24 (d, J=1.6 Hz, 2H), 7.70 (t, J=7.7 Hz, 2H), 7.61 (d, J=7.8 Hz, 2H), 7.15 (d, J=7.7 Hz, 2H), 2.91-2.87 (m, 4H), 1.86-1.80 (m, 4H), 1.42-1.29 (m, 20H), 0.90 (t, J=7.0 Hz, 6H). FIG. 18 was a carbon nuclear magnetic resonance spectrum of 6,6′-(5-bromo-1,3-phenylene)bis(2-octylpyridine) (Compound 12), and the characterization data in the figure were as follows: ¹³C NMR (126 MHz, Chloroform-d) δ 162.69, 155.18, 142.07, 136.94, 130.19, 124.15, 123.46, 121.65, 117.87, 38.52, 31.91, 29.82, 29.53, 29.31, 29.30, 22.70, 14.13.

### (c) Preparation of 6,6′,6″,6′″-(5′-(3,5-bis(6-octylpyridin-2-yl)phenyl)-[1,1′:3′,1″-terphenyl]-3,3″,5,5″-tetrayl)tetrakis(2-octylpyridine) (Ph-3(N\hat{ }C\hat{ }N), Compound 13)

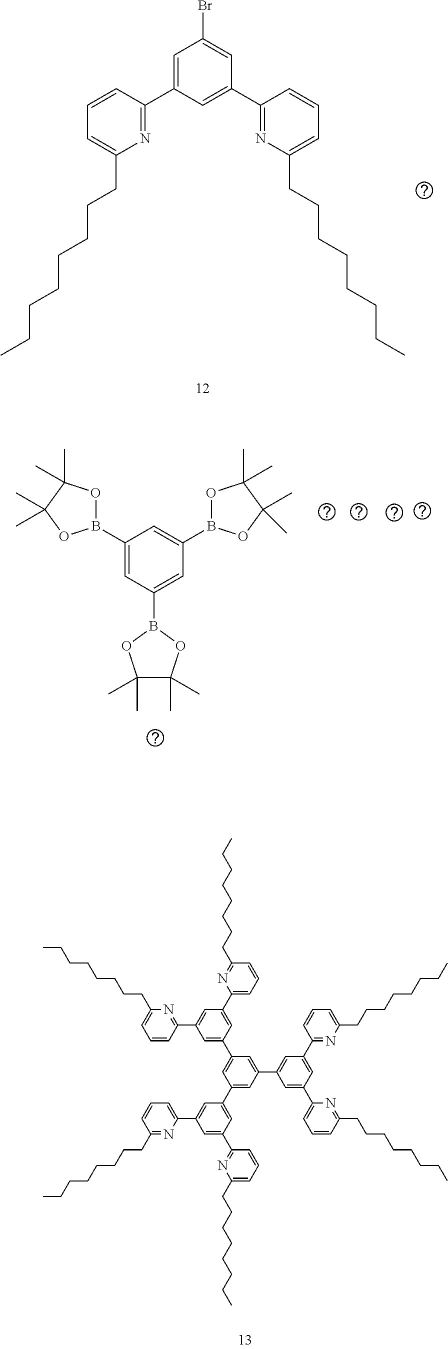

Compound 12 (5.6 mmol), Pd(PPh₃)₄ (58 mg, 0.050 mmol), and K₂CO₃ (15.0 mmol) were added to a mixed solvent of degassed THF/H₂O (108 mL/12 mL) to obtain a suspension, and the suspension was further charged with Ph-3Bpin (1.7 mmol) to obtain a mixed solution. The mixed solution was stirred at 90° C. for 12 h. The solvent was then evaporated to obtain a crude product. The crude product was purified through column chromatography on silica gel to obtain Compound 13 (Ph-3(N\hat{ }C\hat{ }N)).

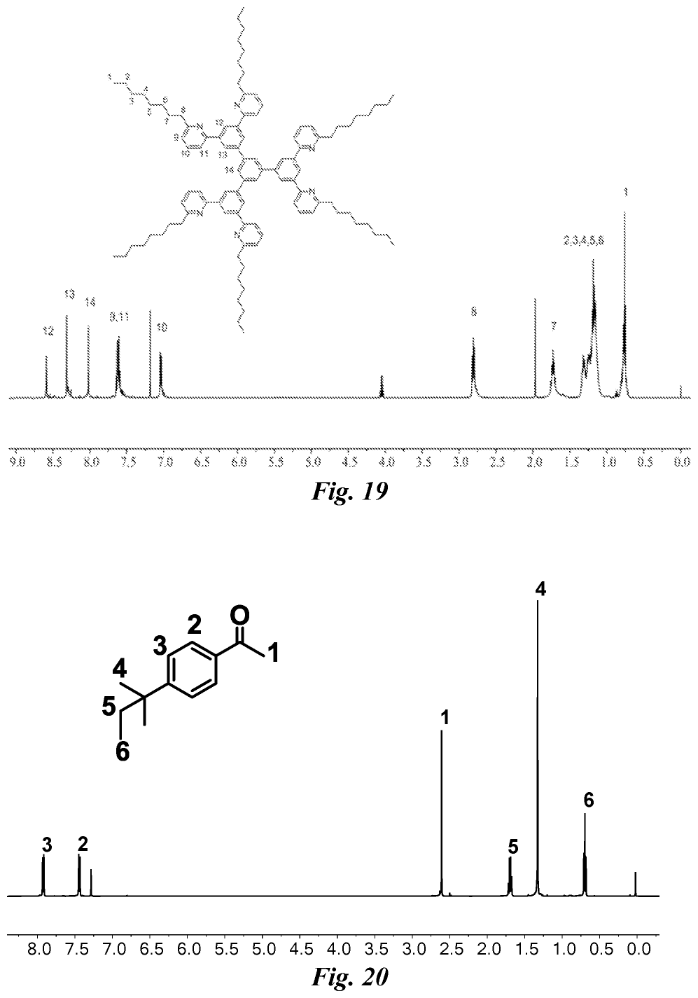

FIG. 19 was a hydrogen nuclear magnetic resonance spectrum of Compound 13 (Ph-3(N\hat{ }C\hat{ }N)), and the characterization data in the figure were as follows: ¹H NMR (500 MHz, Chloroform-d) δ 8.59 (t, J=1.7 Hz, 3H), 8.31 (d, J=1.7 Hz, 6H), 8.02 (s, 3H), 7.65-7.59 (m, 12H), 7.07-7.03 (m, 6H), 2.81 (t, J=7.9 Hz, 12H), 1.73 (ddd, J=9.5, 4.4, 1.9 Hz, 12H), 1.37-1.17 (m, 60H), 0.78-0.75 (m, 18H).

### (d) Preparation of Ph-3(N\hat{ }C\hat{ }N)-3PtCl (Compound 14)

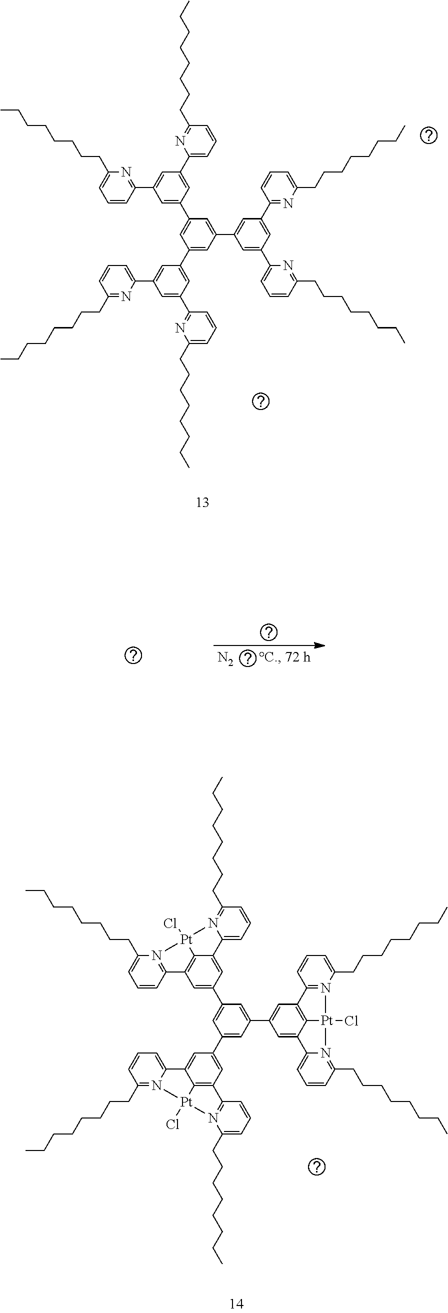

To the mixture of Compound 13 (0.10 mmol) and K₂PtCl₄ (0.22 mmol) was added 7 mL of acetic acid under nitrogen atmosphere. The resulting mixture was bubbled with nitrogen for 15 min with stirring at room temperature, followed by heating at 115° C. for 3 days. After cooling to room temperature, the precipitate was collected by filtrating and washing successively with deionized water (40 mL), ethanol (15 mL), and diethyl ether (30 mL). The obtained precipitate was washed with excessive dichloromethane (25 mL) five times. The resulting precipitate was collected and dried under vacuum to afford Ph-3(N\hat{ }C\hat{ }N)-3PtCl (Compound 14) as a yellow solid.

### (e) Preparation of Ph-3(N\hat{ }C\hat{ }N)-3PtCl-3DCB

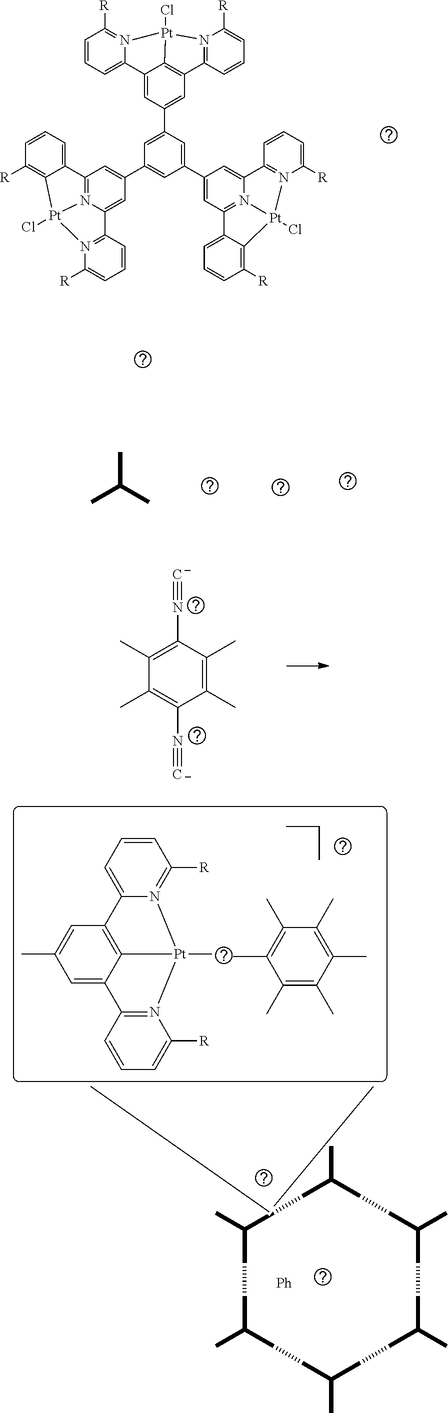

An excess of 1,4-diisocyano-2,3,5,6-tetramethyl-benzene was added to a two-phase solution system of Compound 14 in dichloromethane and water. The two-phase reaction system was stirred and reacted at room temperature for 2 h, the aqueous phase was then separated and transferred to a saturated Ag₂SO₄ aqueous solution. The mixture was stirred and filtered through Celite to obtain a filtrate, and the filtrate was evaporated to dryness under reduced pressure to obtain a solid. The obtained solid was dissolved in anhydrous methanol and dried with magnesium sulfate. After filtration, the solution was concentrated under reduced pressure to obtain a pure product, i.e. Ph-3(N\hat{ }C\hat{ }N)-3PtCl-3DCB as an orange solid.

As shown in the chemical reaction formula above,

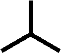

represented Compound 14:

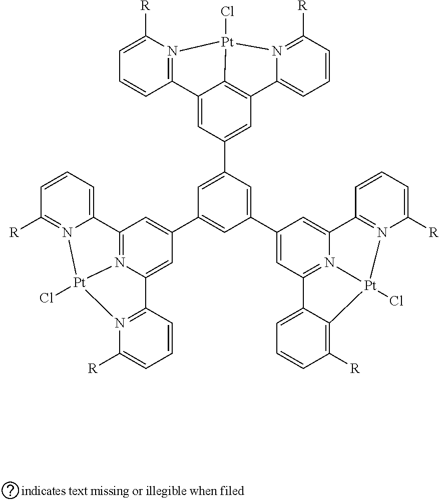

(where R is n-octane), and [symbol] represented 1,4-diisocyano-2,3,5,6-tetramethyl-benzene:

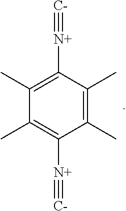

After Compound 14 underwent a chemical reaction with 1,4-diisocyano-2,3,5,6-tetramethyl-benzene, the metal Pt in Compound 14 was connected to the carbon in the isocyano in 1,4-diisocyano-2,3,5,6-tetramethyl-benzene via a coordination bond, wherein the structure of the connection was shown as follows:

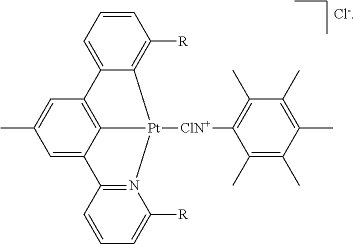

Finally, Ph-3(N\hat{ }C\hat{ }N)-3PtCl-3DCB with a closed ring structure was obtained.

### Synthesis Example 5

This example illustrated the preparation of a two-dimensional coordination polymer having Formula (V).

### (a) Preparation of 1-(4-(tert-pentyl)phenyl)ethan-1-one (Compound 15)

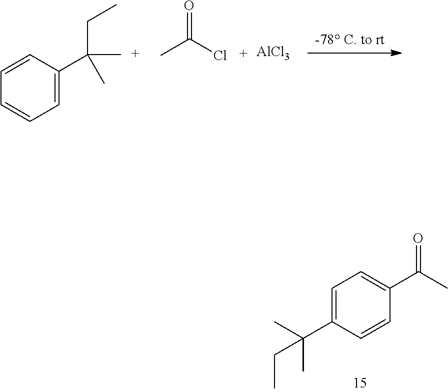

To acetyl chloride (25 ml) was added AlCl₃ (93.1 mmol) under magnetic stirring at −78° C. The mixed solution was stirred for 10 min, to which tert-pentylbenzene (37.3 mmol) was added at the same temperature. The resulting mixed solution was then allowed to warm up to room temperature and stirred for 1 h. It was poured into crushed ice-water mixture (300 ml) to quench the reaction. The crude product was extracted with CH₂Cl₂ (100 ml). The CH₂Cl₂ extraction liquid was washed with saturated NaHCO₃ aqueous solution (150 ml) and water (100 ml), then dried over anhydrous MgSO₄ and concentrated under reduced pressure to obtain a yellow liquid. The resulting yellow liquid was purified by distillation under reduced pressure to give Compound 15 as a pale-yellow liquid, with a yield of 88%.

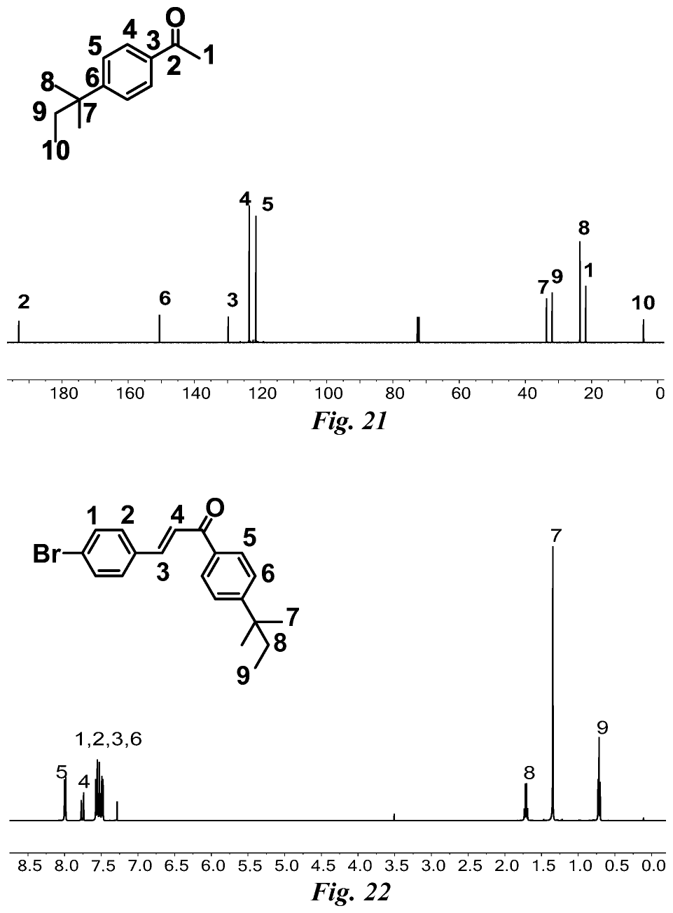

FIG. 20 was a hydrogen nuclear magnetic resonance spectrum of 1-(4-(tert-pentyl)phenyl)ethan-1-one (Compound 15), and the characterization data in the figure were as follows: 1H NMR (500 MHz, Chloroform-d) δ 7.92 (d, J=8.5 Hz, 2H), 7.44 (d, J=8.6 Hz, 2H), 2.61 (s, 3H), 1.70 (q, J=7.5 Hz, 2H), 1.33 (s, 6H), 0.70 (t, J=7.4 Hz, 3H). FIG. 21 was a carbon nuclear magnetic resonance spectrum of 1-(4-(tert-pentyl)phenyl)ethan-1-one (Compound 15), and the characterization data in the figure were as follows: ¹³C NMR (126 MHz, DMSO-d₆) δ 193.06, 150.56, 129.80, 123.45, 121.42, 33.63, 31.93, 23.50, 21.76, 4.30.

### (b) Preparation of 3-(4-bromophenyl)-1-(4-(tert-pentyl)phenyl)prop-2-en-1-one (Compound 16)

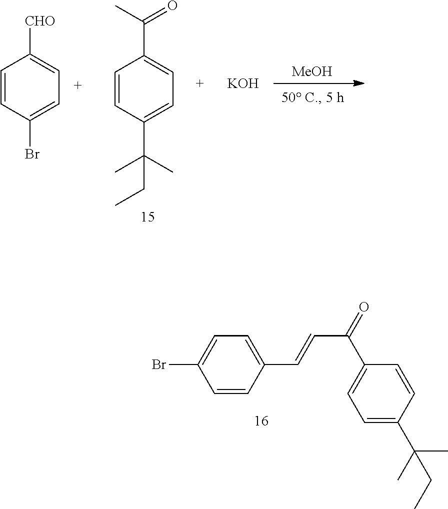

4-Bromobenzaldehyde (10 mmol), Compound 15 (10 mmol), KOH (0.2 mol), and methanol (20 mL) were added to a flask (50 mL). Then, the mixture was stirred at 50° C. for 5 hours. After cooling down to room temperature, the reaction mixture was concentrated by removing the solvent under vacuum, and the product was then purified by column chromatography (EA/PE) to obtain Compound 16.

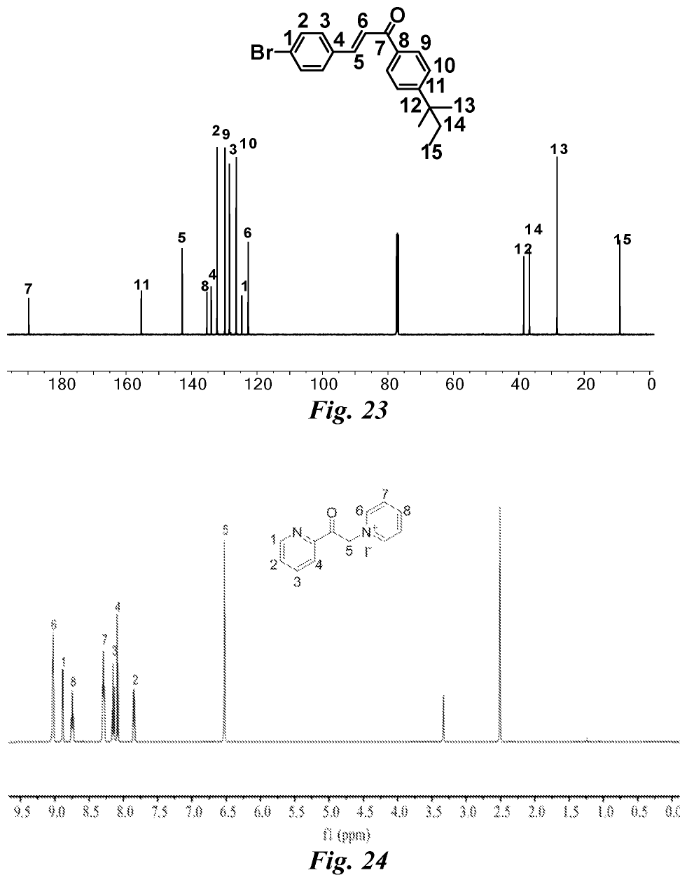

FIG. 22 was a hydrogen nuclear magnetic resonance spectrum of 3-(4-bromophenyl)-1-(4-(tert-pentyl)phenyl)prop-2-en-1-one (Compound 16), and the characterization data in the figure were as follows: ¹H NMR (500 MHz, Chloroform-d) δ 7.99 (d, J=8.4 Hz, 2H), 7.76 (d, J=15.8 Hz, 1H), 7.61-7.47 (m, 7H), 1.70 (t, J=7.4 Hz, 2H), 1.35 (s, 6H), 0.72 (t, J=7.4 Hz, 3H). FIG. 23 was a carbon nuclear magnetic resonance spectrum of 3-(4-bromophenyl)-1-(4-(tert-pentyl)phenyl)prop-2-en-1-one (Compound 16), and the characterization data in the figure were as follows: ¹³C NMR (126 MHz, Chloroform-d) δ 189.75, 155.35, 142.85, 135.32, 133.98, 132.20, 129.78, 128.43, 126.34, 124.65, 122.68, 38.47, 36.73, 28.29, 9.11.

### (c) Preparation of 1-[2-oxo-2-(2-pyridyl)ethyl]pyridinium iodide (Compound 17)

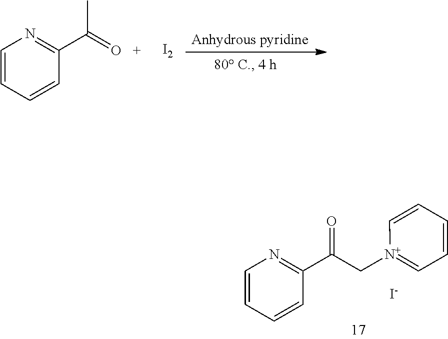

Under anhydrous and oxygen-free conditions, 12 (5.06 g, 20 mmol) was dissolved in anhydrous pyridine (30 mL) and the mixture was stirred and heated to 70° C. for 0.5 h. Then, 2-acetylpridine (2.42 g, 20.0 mmol) was added to the mixed solution and the mixed solution was stirred and heated to 80° C. for 4 h. The mixed solution was cooled and then filtered to obtain a precipitate, the precipitate was washed with ethanol five times. Vacuum drying was then carried out to obtain Compound 17 as a yellow-green solid (4.38 g, yield: 67.2%).

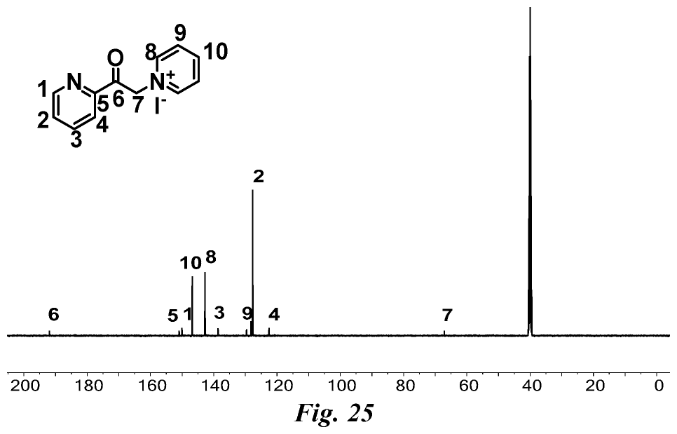

FIG. 24 was a hydrogen nuclear magnetic resonance spectrum of 1-[2-oxo-2-(2-pyridyl)ethyl]pyridinium iodide (Compound 17), and the characterization data in the figure were as follows: ¹H NMR (500 MHz, DMSO-d₆) δ 9.03 (ddt, J=5.1, 3.7, 1.7 Hz, 2H), 8.88 (dt, J=4.8, 1.4 Hz, 1H), 8.74 (ddq, J=7.8, 6.5, 1.6 Hz, 1H), 8.36-8.25 (m, 2H), 8.15 (td, J=7.7, 1.7 Hz, 1H), 8.08 (dt, J=7.8, 1.2 Hz, 1H), 7.85 (ddd, J=7.6, 4.7, 1.4 Hz, 1H), 6.52 (d, J=4.0 Hz, 2H). FIG. 25 was a carbon nuclear magnetic resonance spectrum of 1-[2-oxo-2-(2-pyridyl)ethyl]pyridinium iodide (Compound 17), and the characterization data in the figure were as follows: ¹³C NMR (126 MHz, DMSO-d₆) δ 150.92, 150.04, 146.79, 142.78, 138.64, 129.62, 127.70, 122.53, 67.13.

### (d) Preparation of 4-(4-bromophenyl)-6-(4-(tert-pentyl)phenyl)-2,2′-bipyridine (Compound 18)

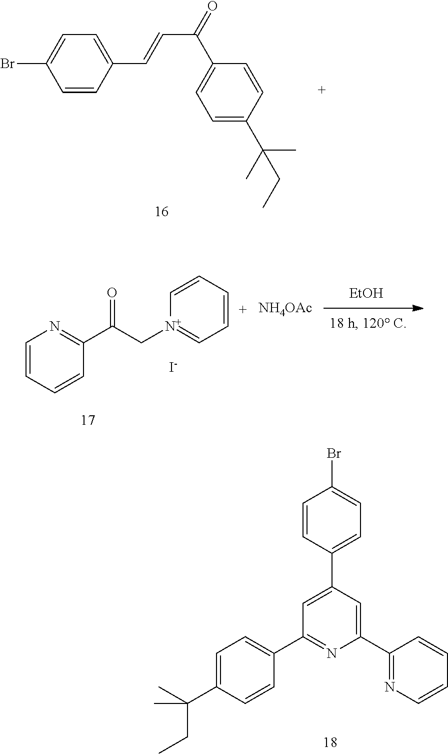

Compound 16 (4.51 mmol), Compound 17 (6.74 mmol) and ammonium acetate (3.45 g, 44.9 mmol) were added to an ethanol solution (25 mL). The reaction mixture solution was refluxed at 120° C. for 18 h, and after cooling to room temperature, distilled water was added to the reaction mixture solution, and a grey precipitate was formed. The precipitate was filtered off, washed with water, and dried to obtain a crude product. The crude product was purified by chromatography on active alumina. Elution with CH₂Cl₂/hexane (2:1) provided a pure product and further recrystallization from ethanol then gave Compound 18 as a white powder.

### (e) Preparation of Ph-3(Ph-C\hat{ }N\hat{ }N) (Compound 19)

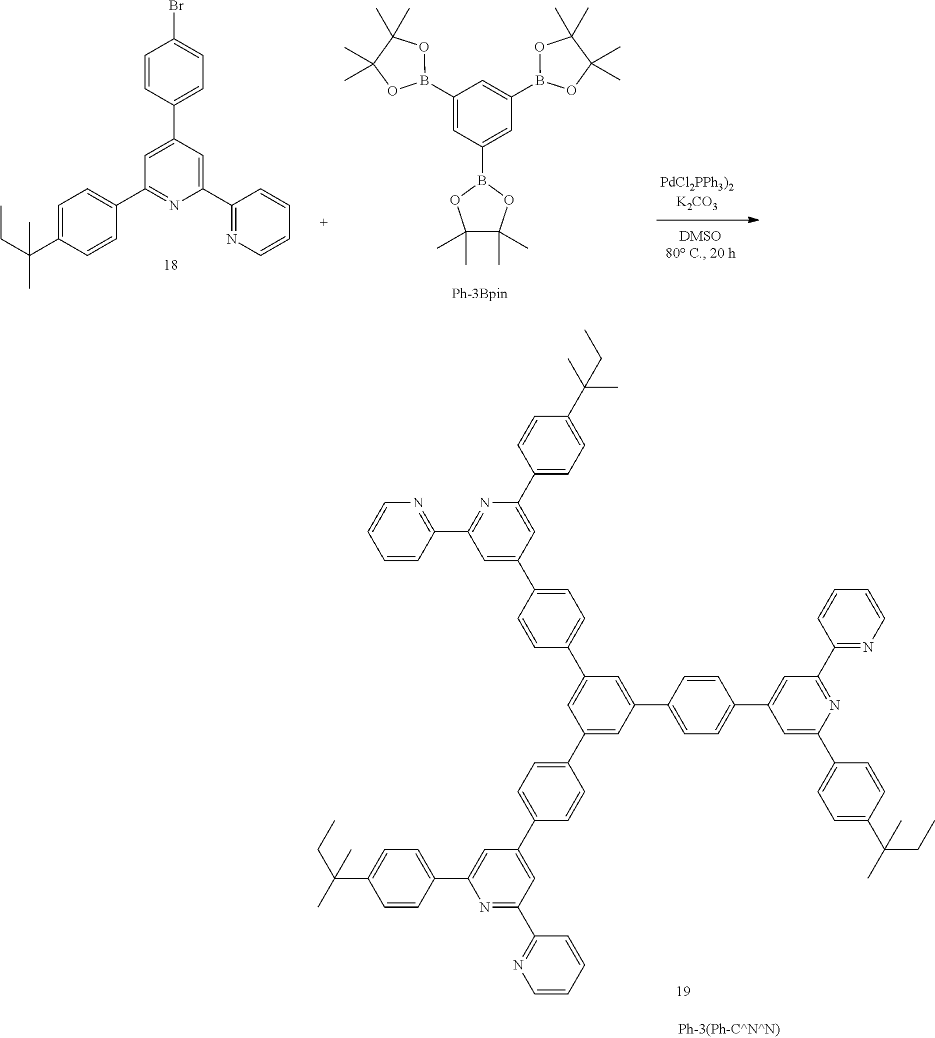

Compound 18 (5.6 mmol), PdCl₂(PPh₃)₂ (0.050 mmol), and K₂CO₃ (15.0 mmol) were added to a degassed dimethyl sulfoxide solvent (DMSO, 108 mL) to obtain a suspension. To the suspension was further added Ph-3Bpin (1.7 mmol) to obtain a mixed solution. The mixed solution was stirred at 80° C. for 20 h. The solvent was then evaporated to obtain a crude product. The crude product was purified through column chromatography on silica gel to obtain Compound 19 (Ph-3(Ph-C\hat{ }N\hat{ }N)).

### (f) Preparation of Ph-3(Ph-C\hat{ }N\hat{ }N)-3PtCl (Compound 20)

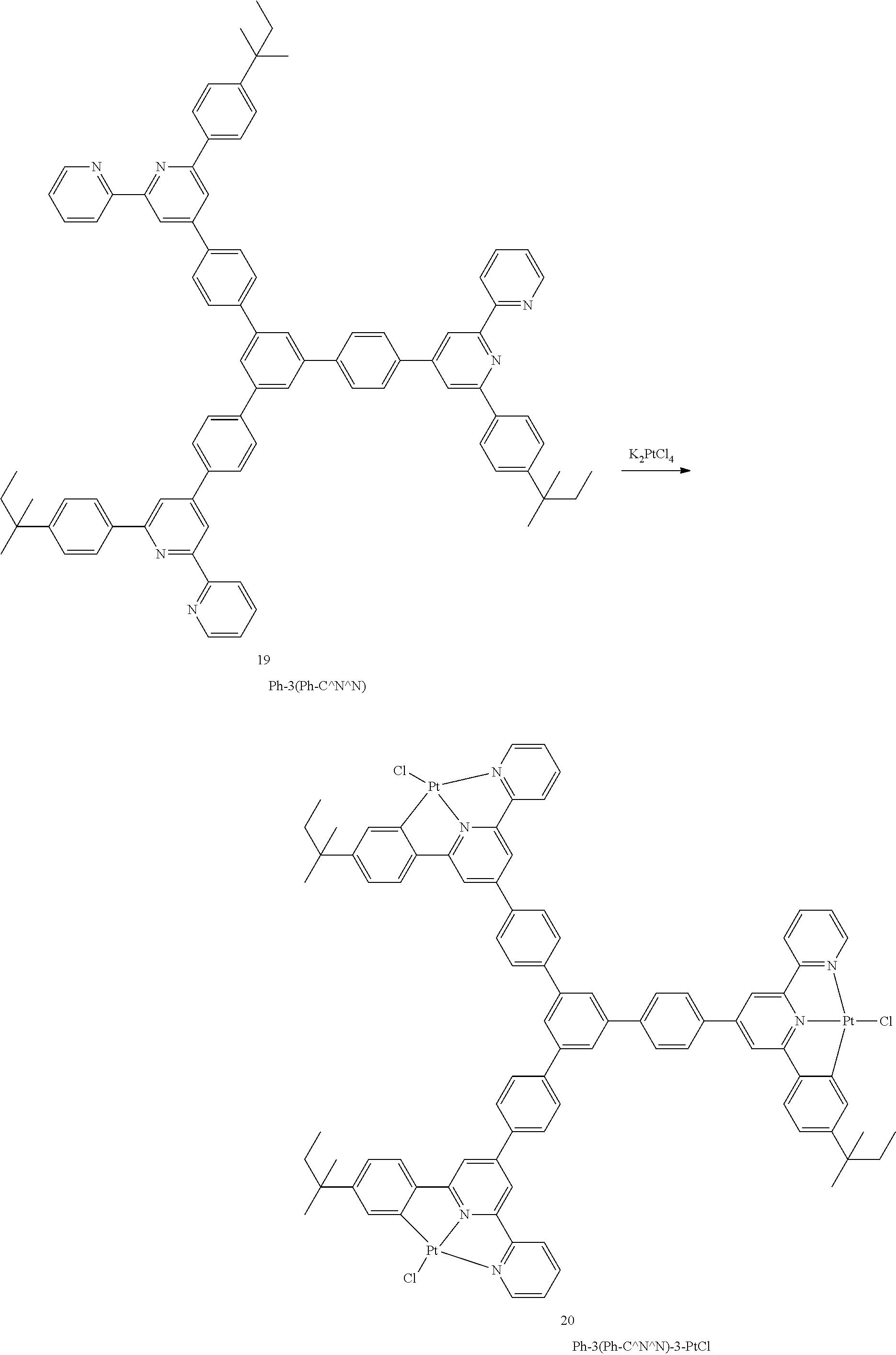

To the mixture of Compound 19 (0.10 mmol) and K₂PtCl₄ (0.22 mmol) was injected 7 mL of acetic acid under nitrogen atmosphere. The resulting mixture was bubbled with nitrogen for 15 min with stirring at room temperature, followed by heating at 115° C. for 3 days. After cooling to room temperature, the precipitate was collected by filtrating and washing successively with water (40 mL), ethanol (15 mL), and diethyl ether (30 mL). The obtained precipitate was washed with excessive CH₂Cl₂ (25 mL) five times. The precipitate was collected and dried under vacuum to afford Ph-3(Ph-C\hat{ }N\hat{ }N)-3PtCl (Compound 20) as a yellow solid.

### (f) Preparation of Ph-3(Ph-C\hat{ }N\hat{ }N)-3PtCl-3DCB

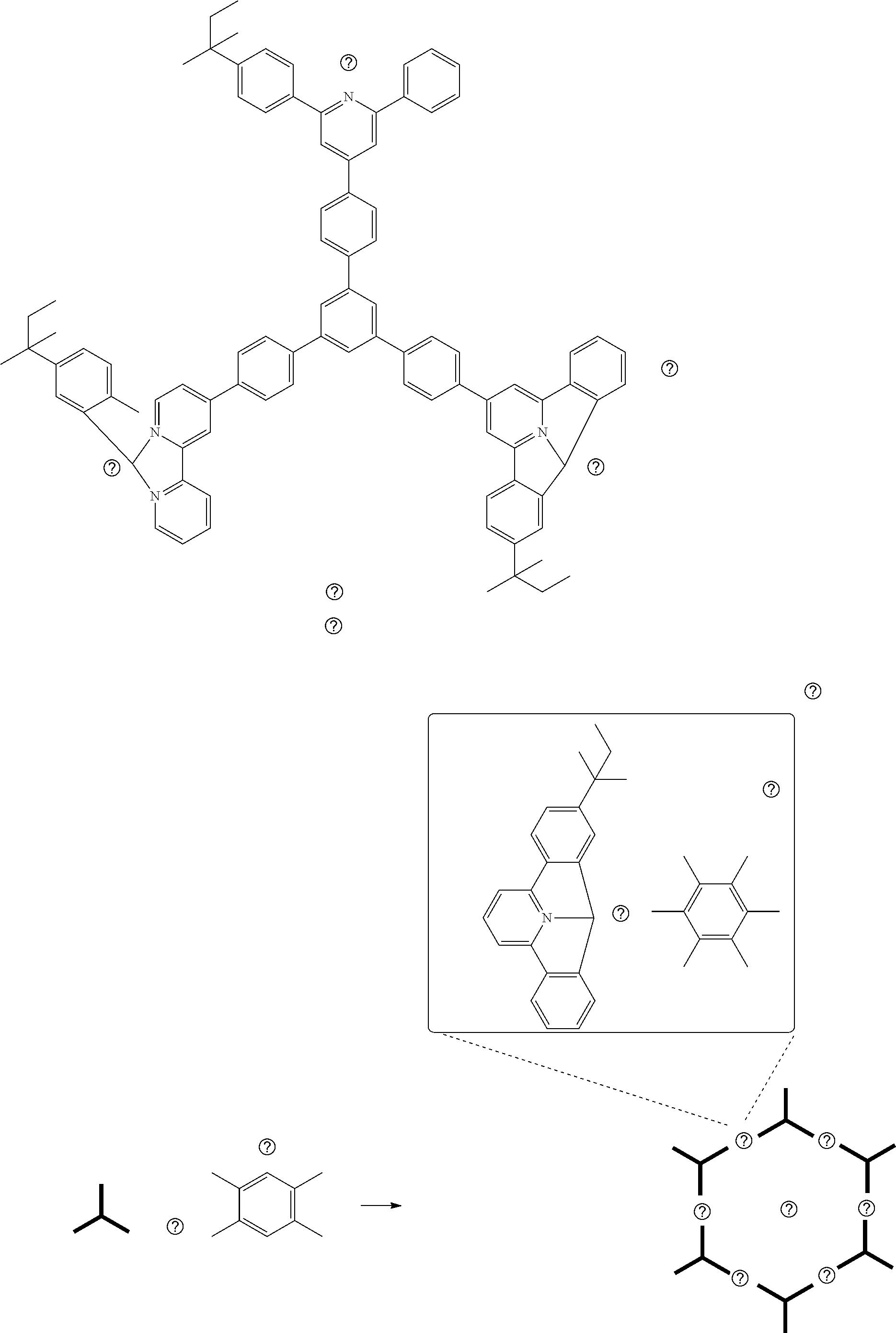

An excess of 1,4-diisocyano-2,3,5,6-tetramethyl-benzene was added to a two-phase system of Compound 20 in dichloromethane and water. The two-phase reaction system was stirred and reacted at room temperature for 2 h, the aqueous phase was then separated and transferred to a saturated Ag₂SO₄ aqueous solution. The mixture was stirred and filtered through Celite to obtain a filtrate, and the filtrate was evaporated to dryness under reduced pressure to obtain a solid. The obtained solid was dissolved in anhydrous methanol and dried with magnesium sulfate. After filtration, the solution was concentrated under reduced pressure to obtain Ph-3(Ph-C\hat{ }N\hat{ }N)-3PtCl-3DCB as an orange solid product.

As shown in the chemical reaction formula above,

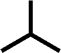

represented Compound 20:

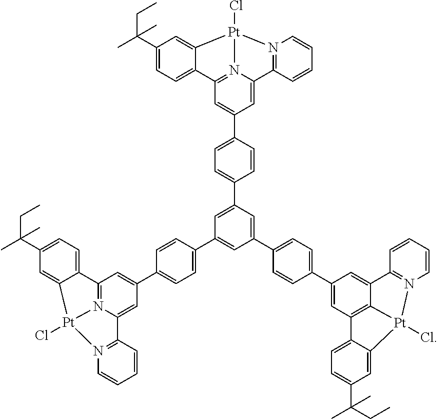

and [symbol] represented 1,4-diisocyano-2,3,5,6-tetramethyl-benzene:

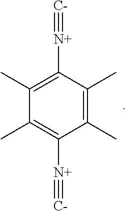

After Compound 20 underwent a chemical reaction with 1,4-diisocyano-2,3,5,6-tetramethyl-benzene, the metal Pt in Compound 20 was connected to the carbon in the isocyano in 1,4-diisocyano-2,3,5,6-tetramethyl-benzene via a coordination bond, wherein the structure of the connection was shown as follows:

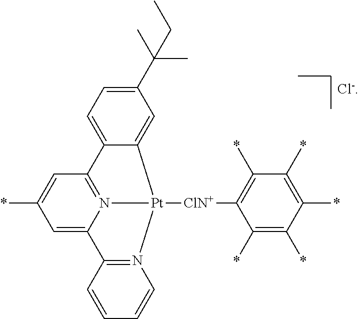

Finally, Ph-3(Ph-C\hat{ }N\hat{ }N)-3PtCl-3DCB with a closed ring structure was obtained.

The preferred particular embodiments of the present invention have been described in detail above. It should be understood that many modifications and changes can be made by those of ordinary skill in the art according to the concept of the present invention without any inventive effort. Therefore, all technical solutions that can be obtained by those skilled in the art through logical analysis, reasoning or limited experiments according to the concept of the present invention on the basis of the prior art should fall within the scope of protection defined by the claims.

1. A two-dimensional coordination polymer having a structure represented by Formula (I): 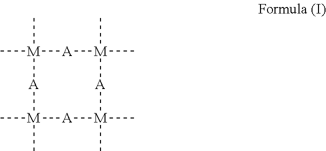
wherein:
A has a structure of 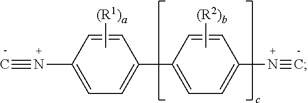
M is a metal element selected from a group consisting of Pt, Ir, Ru, Pd, Ni, Au, Cr, Co, Mo, Mn, Re, and Fe;
R¹ and R² are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
a and b are each independently 0, 1, 2, 3, or 4; and
c is an integer greater than or equal to 0 and less than or equal to 5; and
wherein a carbon in an isocyano in A is connected to a metal M via a coordination bond.

2. The two-dimensional coordination polymer of claim 1, wherein R¹ and R² are independently methyl, a and b are independently 2 or 4, and c is 0 or 1.

3. The two-dimensional coordination polymer of claim 1, wherein R¹ and R² are independently methyl, a is 2, b is 2, and c is 1.

4. The two-dimensional coordination polymer of claim 1, wherein M is Co.

5. A two-dimensional coordination polymer having a structure represented by Formula (II): 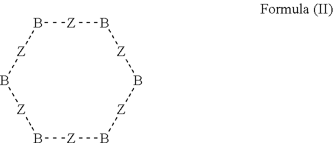
wherein:
B has a structure of 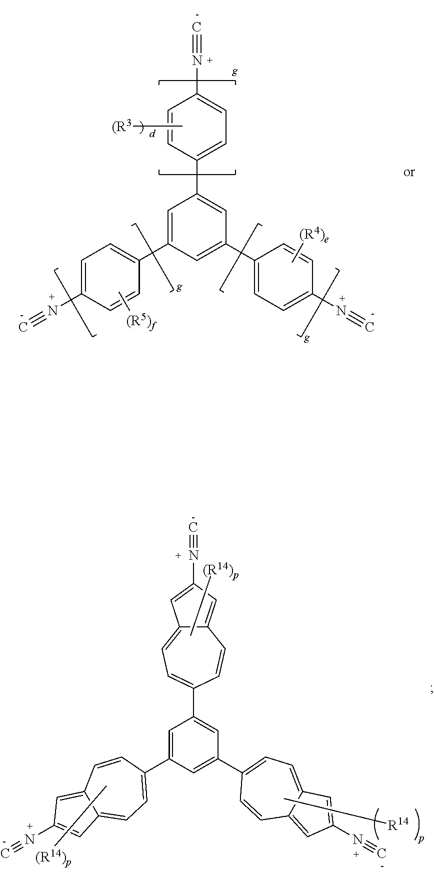
Z has a structure of 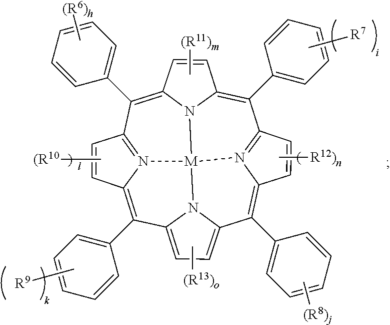
R³, R⁴, R⁵, R⁶, R⁷, R⁸, R⁹, R¹⁰, R¹¹, R¹², R¹³ and R¹⁴ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
d, e, and f are each independently 0, 1, 2, 3, or 4;
h, i, j, and k are each independently 0, 1, 2, 3, 4, or 5;
l, m, n, and o are each independently 0, 1, or 2;
p is 0, 1, 2, 3, 4, 5, or 6;
g is an integer greater than or equal to 0 and less than or equal to 5; and
M is a metal element selected from a group consisting of Pt, Ir, Ru, Pd, Ni, Au, Cr, Co, Mo, Mn, Re, and Fe;
wherein a carbon in an isocyano in B is connected to a metal M in Z via a coordination bond.

6. The two-dimensional coordination polymer of claim 5, wherein R³, R⁴, and R⁵ are independently methyl, d, e, and f are independently 2 or 4, and g is 1 or 2.

7. The two-dimensional coordination polymer of claim 5, wherein R¹⁴ is ethoxycarbonyl, and p is 2.

8. The two-dimensional coordination polymer of claim 5, wherein h, i, j, k, l, m, n, and o are independently 0.

9. The two-dimensional coordination polymer of claim 6, wherein h, i, j, k, l, m, n, and o are independently 0.

10. The two-dimensional coordination polymer of claim 7, wherein h, i, j, k, l, m, n, and o are independently 0.

11. The two-dimensional coordination polymer of claim 5, wherein M is Ru.

12. The two-dimensional coordination polymer of claim 9, wherein M is Ru.

13. The two-dimensional coordination polymer of claim 10, wherein M is Ru.

14. A two-dimensional coordination polymer having a structure represented by Formula (IV): 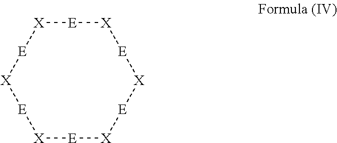
wherein:
E has a structure of 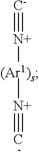
X has a structure of 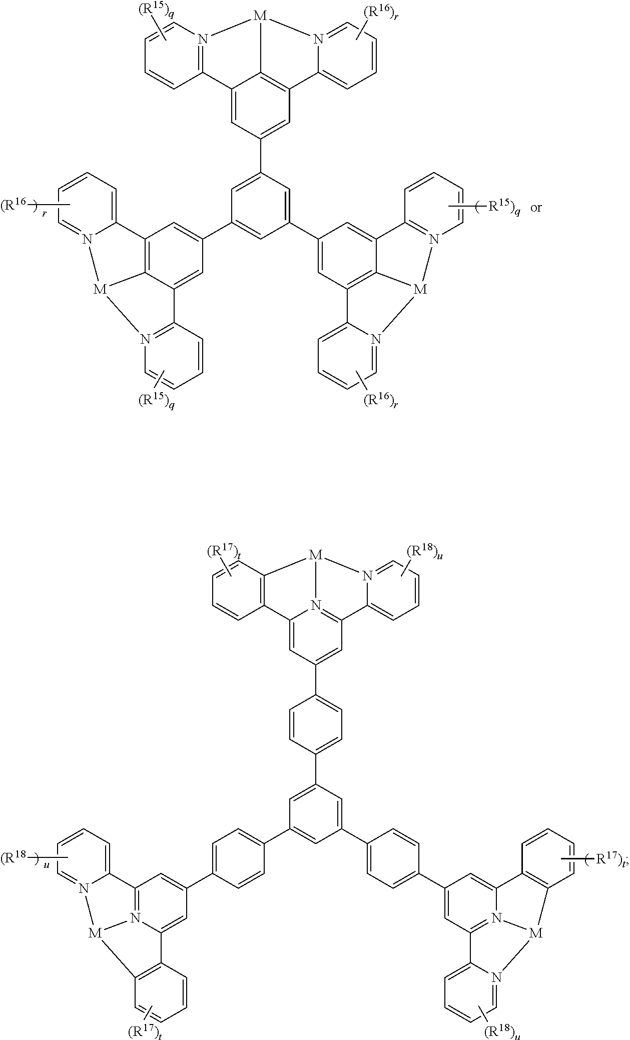
Ar¹ is unsubstituted phenyl, or phenyl substituted with one or more methyl groups;
R¹⁵, R¹⁶, R¹⁷ and R¹⁸ are each independently selected from a group consisting of deuterium, fluoro, cyano, alkyl, alkoxy, fluoroalkyl, hydrocarbon aryl, aryloxy, heteroaryl, silyl, siloxane, siloxy, germyl, deuterated alkyl, deuterated fluorinated alkyl, deuterated alkoxy, deuterated hydrocarbon aryl, deuterated aryloxy, deuterated heteroaryl, deuterated silyl, deuterated siloxane, deuterated siloxy, deuterated germyl, and substituted derivatives thereof;
q, r, t and u are each independently 0, 1, 2, 3, or 4;
s is an integer greater than or equal to 1 and less than or equal to 5; and
M is a metal element selected from a group consisting of Pt, Ir, Ru, Pd, Ni, Au, Cr, Co, Mo, Mn, Re, and Fe;
wherein a carbon in an isocyano in E is connected to a metal M in X via a coordination bond.

15. The two-dimensional coordination polymer of claim 14, wherein Ar¹ is phenyl substituted with 2 or 4 methyl groups, and s is 1.

16. The two-dimensional coordination polymer of claim 14, wherein R¹⁵ and R¹⁶ are independently n-octyl, and q and r are independently 1.

17. The two-dimensional coordination polymer of claim 14, wherein R¹⁷ is isopentyl, t is 1, and u is 0.

18. The two-dimensional coordination polymer of claim 14, wherein M is Pt.

19. The two-dimensional coordination polymer of claim 16, wherein M is Pt.

20. The two-dimensional coordination polymer of claim 17, wherein M is Pt.
